(19) United States
(12) Patent Application Publication
(10) Pub. No.: US 2026/0301298 A1
(43) Pub. Date: Oct. 1, 2026

(54) GRAPHICS PROCESSING

(71) Applicant: Arm Limited, Cambridge (GB)

(72) Inventors: Frank Klaeboe Langtind, Melhus (NO); Philip Carlos Garcia, Austin, TX (US); Andreas Danner Nilsen, Trondheim (NO); Olof Henrik Uhrenholt, Lomma (SE); Philip Berg Bedoukian, Austin, TX (US)

(73) Assignee: Arm Limited, Cambridge (GB)

(21) Appl. No.: 19/350,784

(22) Filed: Oct. 6, 2025

Related U.S. Application Data
(63) Continuation-in-part of application No. 19/284,457, filed on Jul. 29, 2025.
(63) Continuation-in-part of application No. 19/255,031, filed on Jun. 30, 2025.
(63) Continuation-in-part of application No. 19/244,970, filed on Jun. 20, 2025.
Application No. 19/284,457 is a continuation-in-part of application No. 19/093,026, filed on Mar. 27, 2025.

(51) Int. Cl. G06T 15/00; G06T 15/30

(52) U.S. Cl. CPC G06T 15/005; G06T 15/30; G06T 2210/62

(57) ABSTRACT

When generating a render output in which primitives to be rendered can be clipped against clip planes defined for the render output, for a primitive that is to undergo a clipping process as part of its processing for the render output, when the clipping process generates one or more new vertices for the primitive, the clipping process generates position attributes for the new vertices that are generated as a result of the clipping process, and, thereafter, the rendering stage uses the position attributes generated by the clipping process for the new vertices generated as a result of the clipping process for the primitive when determining the values of one or more non-position attributes when processing the primitive that underwent the clipping process for the render output.

### CLAIM OF PRIORITY

This application claims is a continuation-in-part of U.S. Patent Application No. 19/284,457 filed Jul. 29, 2025, by Garcia et al., entitled, “GRAPHICS PROCESSING,” which is a continuation-in-part of U.S. Patent Application No. 19/093,026 filed Mar. 27, 2025, by Halstvedt, entitled, “GRAPHICS PROCESSING. This application is also a continuation-in-part of U.S. Patent Application No. 19/244,970 filed Jun. 20, 2025, by Garcia et al., entitled, “GRAPHICS PROCESSING,”. This application is also a continuation-in-part of U.S. Patent Application No. 19/255,031 filed Jun. 30, 2025, by Ruud et al., entitled, “GRAPHICS PROCESSING,” all of which are incorporated herein in their entirety.

### BACKGROUND

The technology described herein relates to graphics processing, and in particular to the operation of a tile-based graphics processor and graphics processing pipeline when primitives to be rendered can be “clipped”.

Computer graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles, quadrilaterals, points, lines, or groups thereof.

Each primitive is usually defined by and represented as a set of vertices (e.g. three vertices in the case of triangular primitive). For a given graphics processing output, e.g. frame to be displayed, there will typically be a set of vertices defined for the output in question. The primitives to be processed for the output will then be indicated as comprising given vertices in the set of vertices for the output being generated.

Typically, the overall output, e.g. frame to be generated, will be divided into smaller units of processing, referred to as “draw calls”. Each draw call will have a respective set of vertices defined for it and respective primitives that use those vertices. For a given frame, there may, e.g., be of the order of a few thousand draw calls, and hundreds of thousands (or potentially millions) of primitives.

Each vertex for a primitive will have associated with it a set of data (such as position, colour, texture and other attributes data) representing the vertex. This vertex data is processed by a graphics processor to generate the desired graphics processing output (render target), such as a frame for display. This typically comprises “assembling” primitives using the vertices, and then processing the so-assembled primitives.

One form of graphics processing uses so-called “tile-based” rendering. In tile-based rendering, the render output (i.e. the output of the rendering process, such as an output frame to be displayed) is rendered as a plurality of smaller area regions, usually referred to as “tiles”. The render output is typically divided (by area) into regularly-sized and shaped rendering tiles (they are usually e.g., squares or rectangles). The tiles are each rendered separately (e.g. one after another). The rendered tiles are then combined to provide the complete render output (e.g. frame for display).

Other terms that are commonly used for “tiling” and “tile-based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.

When performing tile-based graphics processing, there will normally be some initial geometry processing, such as vertex processing (vertex shading) of attributes for vertices to be used for primitives for the render output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated.

(In tile-based graphics processing, it is usually desirable to be able to (try to) identify the geometry (e.g. primitives) for the render output that need to be processed for a given rendering tile (so as to avoid unnecessarily processing geometry that does not actually apply to a rendering tile). To facilitate this, in tile-based graphics processing, there is usually a tiling/binning process that is performed that generates appropriate data structures, such as lists of primitives that apply to a tile or tiles, for use then to identify geometry that needs to be processed for a respective rendering tile.)

Once the binning/tiling process has generated the necessary data structures for identifying geometry to be processed for respective tiles of the render output, the geometry can then be, and will be, subjected to appropriate rendering/fragment processing. This may comprise, for example, rasterising primitives to be processed to fragments, fragment shading of the fragments, and/or performing ray tracing operations. This operation is performed on a tile-by-tile basis, using the data structures generated by the tiling/binning process to identify the geometry (e.g. primitives) that need to be processed for a respective rendering tile.

The rendered tiles may then be combined appropriately to provide the overall render output (e.g. frame for display).

Graphics processing may use so-called “clipping”, e.g. to avoid rendering geometry where it is not required. There may, for example, be near and far clipping planes defined for a render output (e.g. frame to be displayed), and also clipping planes that are defined around the, e.g. x and y edges, of the render output, to eliminate geometry that will fall outside the desired view port (view frustum), for example.

Graphics APIs, such Vulkan, OpenGL and Direct3D, also permit the user (the application programmer) to define one or more “user-defined” clip planes, against which geometry can be clipped (in addition to any clip planes defining the view frustum/view port boundary). Where user-defined clip planes can be used, typically a plurality, e.g. up to eight, user-defined clip planes can be defined for a given render output.

When performing clipping, when a vertex for a primitive falls outside a clip plane (such that the primitive to which the vertex belongs needs to be “clipped”), normally a new vertex or vertices that are positioned on the appropriate clip plane are defined (i.e. such that new vertices and correspondingly new primitives are defined to take account of the effect of the clipping).

FIG. 1 illustrates this and shows an exemplary primitive 101 having a vertex 102 that falls outside the desired view port clip space 103. As shown in FIG. 1, to clip the primitive 101 to the right hand plane (edge) of the clip space 103, two new vertices 104, 105 lying on that plane (edge) of the clip space 103 are generated, to thereby create two new primitives 106, 107, that fall entirely within the clip space 103 (that will then be rendered instead of the original primitive 101).

Clipping against a user-defined clip plane is performed in a similar manner, i.e. by generating appropriate new vertices that lie on the clip plane, and correspondingly new primitives including those vertices, for the rendering process.

The Applicants believe that there remains scope for improved methods and apparatus for handling clipping in tile-based graphics processing.

### BRIEF DESCRIPTION OF THE DRAWINGS

Embodiments of the technology described herein will now be described by way of example only and with reference to the accompanying drawings, in which:

FIG. 1 illustrates the operation of clipping in graphics processing;

FIG. 2 shows an exemplary data processing system in which the technology described herein may be implemented;

FIG. 3 shows an exemplary graphics processing pipeline;

FIG. 4 shows schematically a graphics processor that may be operated in accordance with the technology described herein;

FIGS. 5 and 6 show exemplary binning data structures;

FIG. 7 shows an exemplary render output with exemplary clip planes;

FIG. 8 shows the binning and clipping operation in an embodiment;

FIGS. 9 and 10 show the binning and clipping operation in an embodiment in more detail;

FIGS. 11 and 12 show the effect of clipping for exemplary primitives;

FIG. 13 shows exemplary bounding boxes used for the binning process for a primitive that is to undergo a clipping process;

FIG. 14 shows the generation of packets for providing to the rendering process in an embodiment in more detail;

FIG. 15 shows the result of the clipping process for the exemplary primitives shown in FIG. 12;

FIG. 16 shows an exemplary packet including a primitive that is to undergo a clipping process generated by the binning process in an embodiment;

FIG. 17 shows an exemplary packet including a primitive that is to undergo a clipping process after being updated by the clipping process in an embodiment;

FIG. 18 shows an exemplary set of primitive commands which may be included in a packet in an embodiment;

FIG. 19 shows an exemplary entry for new vertices that are generated as a result of the clipping process for a primitive in an embodiment; and

FIG. 20 shows the rendering process for a primitive in an embodiment in more detail.

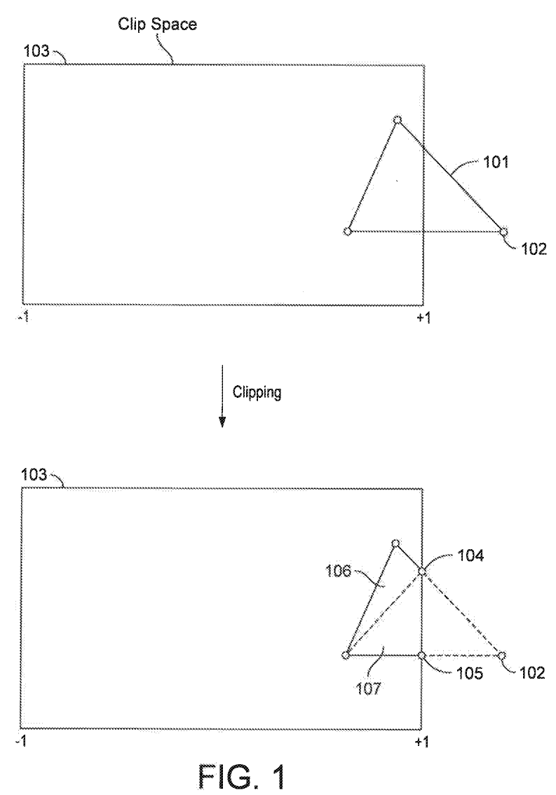

Like reference numerals are used for like features in the Figures, where appropriate.

### DETAILED DESCRIPTION

A first embodiment of the technology described herein comprises a method of operating a graphics processor when executing a tile-based graphics processing pipeline to generate a render output, the graphics processing pipeline being executed comprising:

a sequence of one or more geometry processing stages to perform geometry processing;

a binning stage that performs a binning process to generate data structures for identifying geometry to be processed for respective rendering tiles of a render output being generated;

a rendering stage for rendering tiles of a render output being generated;

the method comprising, when generating a render output in which primitives to be rendered can be clipped against a clip plane defined for the render output, for a primitive to be processed for the render output being generated and that is to undergo a clipping process as part of its processing for the render output:

performing a clipping process for the primitive; and

when the clipping process generates one or more new vertices for the primitive, the clipping process generating position attributes for the new vertices that are generated as a result of the clipping process;

and, thereafter:

the rendering stage using the position attributes generated by the clipping process for the new vertices generated as a result of the clipping process for the primitive when determining the values of one or more non-position attributes when processing the primitive that underwent the clipping process for the render output.

A second embodiment of the technology described herein comprises a graphics processor operable to execute a tile-based graphics processing pipeline to generate a render output, the graphics processor comprising one or more processing circuits configured to execute a graphics processing pipeline comprising:

a sequence of one or more geometry processing stages to perform geometry processing;

a binning stage that performs a binning process to generate data structures for identifying geometry to be processed for respective rendering tiles of a render output being generated;

a rendering stage for rendering tiles of a render output being generated;

wherein:

the graphics processor further comprises a clipping processing circuit configured to, when the graphics processor is generating a render output in which primitives to be rendered can be clipped against a clip plane defined for the render output, for a primitive to be processed for the render output being generated and that is to undergo a clipping process as part of its processing for the render output:

perform a clipping process for the primitive; and

when the clipping process generates one or more new vertices for the primitive, generate position attributes for the new vertices that are generated as a result of the clipping process;

and

the rendering stage processing circuit is configured to use the position attributes generated by the clipping process for new vertices generated as a result of the clipping process for a primitive when determining the values of one or more non-position attributes when processing a primitive that underwent the clipping process for a render output.

The technology described herein relates to tile-based graphics processing, and in particular to handling primitives that may be “clipped” by a clip plane (whether user defined or otherwise) when performing tile-based graphics processing.

As discussed above, when a graphics primitive is clipped against a clip plane, normally a new vertex or vertices that are positioned on the appropriate clip plane are generated (defined) to take account of the effect of the clipping. In order to appropriately process those new vertices (and the new primitives that they define) when rendering a “clipped” primitive, the appropriate vertex attributes, such as positions, and other non-position attributes, such as colours, transparency, etc., for the new vertices will need to be provided to the rendering process. While it will be possible for the clipping process to generate any and all of the vertex attributes required for any new vertices that are generated as a result of the clipping process, the Applicants have recognised that it may be advantageous not to do that.

In the technology described herein, rather than simply generating all the required attributes for any new vertices generated as a result of the clipping process as part of the clipping process itself, (at least) (and as will be discussed further below, in an embodiment only) position attributes are generated by the clipping process for any new vertices that are generated as a result of the clipping process for a primitive. Other (non-position) attributes that are required for new vertices generated as a result of the clipping process (such as colours) are then generated during and as part of the rendering process, using the position attributes generated by the clipping process.

In other words, in the technology described herein, the generation of the attributes for new vertices generated as a result of the clipping process is split into (at least) two parts, with the clipping process generating some but not all of those attributes, and then further attributes being generated as part of the rendering process.

The Applicants have recognised in this regard that by only generating some (e.g., and in an embodiment only position) attributes as part of the clipping process that, as will be discussed in more detail below, can simplify the operation of the clipping process itself, and in particular, in the case where the clipping process is performed by executing a “clip” shader program, can, for example, and in an embodiment, facilitate the use of a common clip shader program for all draw calls and, for example, simplify the compilation of the clip shader program (as it may, for example, avoid the clip shader program needing to take account of different draw calls using different numbers and/or types of vertex attributes).

Furthermore, it may reduce and constrain (and allow to be known) the amount of (vertex attribute) data that will be produced by the clipping process for each new vertex, thereby limiting the overhead and memory bandwidth for the clipping process (and in a known manner).

The technology described herein can avoid therefore, for example, having to allocate memory space for all attributes that may be required for a new vertex generated as a result of the clipping process for a primitive at the clipping stage, thereby simplifying the handling of the clipping process for primitives.

Furthermore, the Applicants have recognised that in practice the rendering process of a graphics processor/graphics processing pipeline may (and in an embodiment does) already include functionality for deriving attribute values as part of the rendering process (and when performing rendering for a primitive), which processes can correspondingly be used to derive appropriate attribute values for vertices generated as a result of a clipping process for a primitive from position attributes for those vertices.

For example, and in an embodiment, and as will be discussed further below, the rendering process may already include an attribute (a varying) interpolation process for interpolating the values of attributes (varyings) (such as colours) for sampling positions for primitives being rendered, and such interpolation processes can correspondingly be used in the case of clipped primitives and new vertices generated as a result of the clipping of a primitive to correspondingly derive attribute values for sampling positions for a primitive that has undergone a clipping process from appropriate position information for the clipped primitive.

The technology described herein can thus provide a more effective and efficient mechanism for handling the clipping of primitives in tile-based graphics processing systems.

The graphics processor that is operated in the manner of the technology described herein can be any suitable and desired graphics processor (that executes a tile-based graphics processing pipeline).

The (tile-based) graphics processing pipeline that the graphics processor executes can correspondingly be any suitable and desired tile-based graphics processing pipeline that a graphics processor can execute. The graphics processing pipeline should, and in an embodiment does, comprise (at least) a sequence of one or more geometry processing stages to perform geometry processing, a binning stage that generates data structures for identifying geometry to be processed for respective rendering tiles of a render output being generated, and a rendering stage for rendering tiles of a render output being generated.

The geometry processing that is and can be performed in the technology described herein can comprise any suitable and desired sequence of one or more geometry processing stages that may be performed as part of a graphics processing pipeline.

In an embodiment, the geometry processing comprises one or more of, and in an embodiment plural of, the following geometry processing stages: an input assembly stage; a position shader (position shading); a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback stage. The geometry processing may comprise one or more of these stages, as desired.

The sequence of one or more geometry processing stages is in an embodiment implemented and executed as a geometry processing pipeline, comprising the sequence of one or more geometry processing stages in question.

The geometry processing may, in effect, operate on, and process, individual geometry elements, such as, and in an embodiment, (individual) primitives (and in one embodiment, that is the case).

In an embodiment the geometry processing, in effect, operates on, and processes, respective groups of geometry elements (such as, and in an embodiment, respective groups of primitives).

In an embodiment the geometry processing generates (and processes) respective (geometry) packets that each store data for geometry to be processed (for the render output in question).

In an embodiment a (and each) (geometry) packet that the geometry processing generates stores data for a set of one or more primitives (and in an embodiment for a set of plural primitives) to be processed (for the render output in question).

Each (geometry) packet may store any suitable and desired data for the geometry (e.g. set of one or more primitives) that it relates to. For example, a (geometry) packet may, and in an embodiment does, store appropriate attributes, such as positions and other (non-position) varyings, for a set of (in an embodiment plural) vertices for the geometry (e.g. set of primitives) that the packet relates to, for example, and in an embodiment, together with a set of identifiers (indices) for the vertices that can be used to determine how the vertices are used for the geometry (e.g. primitives) that the packet relates to. A packet may also store attributes and identifiers for the geometry, e.g. primitives, itself, if desired, and/or other, e.g., state, information relating to the geometry that the packet relates to.

Other arrangements would, of course, be possible.

The initial (geometry) packets that are generated by the geometry processing may be created in any suitable and desired manner. For example geometry (e.g. primitives) and/or work items (e.g. vertices) relating to that geometry may be progressively added to a packet, e.g. until a condition for finishing the packet (and, if necessary, starting a new packet), such as a maximum amount of geometry (e.g. primitives) and/or work items for the packet being met, is reached.

In an embodiment, each respective geometry processing stage of the sequence of one or more geometry processing stages for the geometry processing (pipeline) that is being executed, generates a respective geometry packet(s), and provides that respective geometry packet as an input packet to a next geometry processing stage of the sequence (if any), with that next geometry processing stage of the sequence then processing the input packets that it receives to generate one or more output geometry packets, that are then provided as inputs to a next geometry processing stage of the sequence (if any), and so on.

Thus, in an embodiment, the first stage of the geometry processing, which in an embodiment comprises position shading or vertex shading (comprising both position shading and non-position varying shading, for example), acts as an “input packetizer” that generates initial packets storing data for geometry to be processed. These initial geometry packets are then in an embodiment appropriately processed by (any) subsequent stages of the geometry processing to generate, for example, modified versions of the initial geometry packets and/or to generate additional geometry packets, as required. For example, a mesh shader may generate multiple packets from a single input (e.g. task shader) packet.

The binning stage/process operates to generate data structures for identifying geometry (e.g. primitives) to be processed for respective rendering tiles of a render output being generated.

As the technology described herein relates to tile-based graphics processing, the render output will be, and is in an embodiment, divided into a plurality of tiles for rendering purposes and the render output is generated by separately rendering each tile the render output is divided into, and combining the rendered tiles.

(Correspondingly, the graphics processor will, and in an embodiment does, include one or more tile buffers that store rendered data for a rendering tile being rendered, e.g., until the rendering of the rendering tile has been completed, and a write out circuit coupled to the tile buffer(s) for writing (completed) rendering tiles to other storage, such as a frame buffer in external memory, for use.)

The tiles that the render output is divided into (and processed as) in this regard may comprise any suitable and desired (respective) regions (areas) of the render output that is being generated. The rendering tiles are in an embodiment all the same size and shape (i.e. regularly sized and shaped tiles are in an embodiment used), although this is not essential. The tiles are in an embodiment rectangular, and in an embodiment square. Each tile may correspond to an array of contiguous sampling positions, for example each tile being 16 x 16 or 32 x 32 or 64 x 64 sampling positions in size.

The binning stage/process should, and in an embodiment does, process the geometry, e.g. primitives and/or packets, it receives for processing to generate one or more data structures that can be used to determine whether (the respective) geometry, e.g. packets, should be processed for respective rendering tiles. Thus, the binning stage/process in an embodiment generates one or more data structures that can be used to determine whether geometry to be processed, and e.g., and in an embodiment, whether packets storing data for geometry to be processed, should be processed for a rendering tile.

The “binning” data structures that are generated by the binning stage/process for this purpose can take any suitable and desired form. For example, they could comprise lists of geometry (e.g. primitives or packets) to be processed for respective rendering tiles or sets of plural rendering tiles (which geometry, e.g. packet, “tile” lists can then be used to determine which geometry, e.g. primitives or packets, apply to a given tile).

In an embodiment, the (binning) data structures that can be used to determine whether geometry to be processed should be processed for a rendering tile comprise, in an embodiment hierarchies of, bounding boxes that can be used for that purpose.

Thus, in an embodiment, the binning process generates (binning) data structures that can be used to determine whether packets storing data for a set of one or more primitives to be processed should be processed for a rendering tile that comprise, in an embodiment hierarchies of, bounding boxes that can be used for that purpose. In an embodiment this comprises both bounding boxes for respective individual packets, together with bounding boxes for respective groups of plural packets (and, if desired, for respective groups of groups of plural packets, and so on, if desired).

In this case to determine geometry, e.g. packets, that should be processed for a rendering tile, the rendering tile can be, and will be, and in an embodiment is, compared against the respective bounding boxes to identify the geometry, e.g. those packets, that apply to the tile.

The binning stage/process can generate the data structures to be used to determine which geometry, e.g. primitives or packets, should be processed for a rendering tile in any suitable and desired manner. In an embodiment it uses an appropriate bounding box or boxes for geometry, e.g. for a primitive or packet, for this purpose.

For example, in the case where the binning stage/process prepares lists of primitives or packets to be processed for tiles, a bounding box for a primitive or packet can be compared to the tiles’ positions to identify which tile(s) and/or sets of plural tiles the primitive or packet applies to.

In the case where the binning data structure(s) comprises bounding boxes for geometry, e.g. packets or primitives, the bounding box for geometry, e.g. a packet or primitive, can be included in those data structures appropriately.

The bounding box for geometry, e.g. a primitive or packet, for this purpose, can be determined in any suitable and desired manner. For example, in the case of a bounding box for an individual primitive, the (positions of the) vertices for the primitive can be used to derive an appropriate bounding box for the primitive. In the case of a packet comprising plural primitives, the positions of (the vertices of) the primitives for the packet can be used to derive a bounding box for the packet as a whole.

Other arrangements would, of course, be possible.

Where appropriate, the processing in an embodiment also comprises determining bounding boxes for the individual primitives in a packet, and using those individual primitive bounding boxes to derive a bounding box for the (processed) packet that the binning stage is generating, and to generate one or more binning data structures that can be used to determine whether the primitives should be processed for a rendering tile (which may, e.g., comprise generating appropriate lists of primitives to be processed for a rendering tile or sets of plural rendering tiles based on the primitive bounding boxes, and/or including the primitive bounding boxes in the bounding box based binning data structures that the binning stage generates, as appropriate).

In an embodiment, the binning stage/process also performs (appropriate) culling operations for primitives, e.g., and in an embodiment to, (try to) cull primitives based on the view frustum and/or the facing direction of the primitives.

In an embodiment, the binning process operates to generate respective (primitive) packets that each store data for a set of one or more primitives (and in an embodiment for a set of plural primitives) to be rendered. These primitive packets may, e.g., and in an embodiment, be generated based on and using (geometry) packets generated by previous geometry processing.

Each (primitive) packet generated by the binning process may store any suitable and desired data for the set of one or more primitives that it relates to. It can, and in an embodiment does, store appropriate attributes, such as positions and, optionally, other (non-position) varyings, for a set of (in an embodiment plural) vertices for the set of primitives that the packet relates to, for example, and in an embodiment, together with a set of identifiers (indices) for the vertices that can be used to determine how the vertices are used for the primitives that the packet relates to. The packet in an embodiment also stores one or more bounding boxes corresponding to and for use in relation to the primitives that the packet relates to.

A (primitive) packet generated by the binning process may also store attributes and identifiers for the primitives themselves, if desired, and/or other, e.g., state, information relating to the primitives that the packet relates to.

In an embodiment the binning process generates packets that indicate for a primitive that the packet relates to (includes) one or more of, in an embodiment plural of, and in an embodiment all of: a bounding box for the primitive, an identifier for the primitive, an instance identifier for the primitive (where necessary), and the vertices for the primitive (in an embodiment by specifying the location of the attributes for the vertices of the primitive in the packet). This may be done, for example, and in an embodiment, by including appropriate “primitive” commands in the packet indicating this information. The packet in an embodiment also stores vertex attributes, including at least vertex positions, and in an embodiment other (non-position) attributes, for the vertices for the primitives that it relates to.

The binning process in an embodiment also generates and stores in an appropriate data structure(s) (whether in the primitive packets themselves or as a separate data structure(s)) bounding boxes for the respective packets that it is generating, and, in an embodiment, bounding boxes for respective groups of such packets (and so on, as desired).

Once the binning stage has generated the necessary binning data structures, then the (geometry for the) render output can be rendered (by the rendering stage of the graphics processing pipeline).

The rendering will be performed on a tile by tile basis (as the graphics processor is executing a tile based graphics processing pipeline), and so accordingly, the rendering stage will, and in an embodiment does, use the binning data structures generated by the binning stage to identify geometry, e.g. packets, to be processed for respective rendering tiles. Thus, for a (and each) rendering tile to be processed for generating the rendering output, the binning data structure(s) generated by the binning stage will be, and are in an embodiment, used to identify geometry, e.g. packets storing data for geometry, to be processed for the rendering tile in question.

This can be done in any suitable and desired manner, and should, and in an embodiment does, depend upon the nature of the binning data structures that the binning stage has generated. For example, where the binning stage generates lists of primitives and/or packets to be processed for respective rendering tiles or sets of rendering tiles, those lists can be used to identify the primitives and/or packets to be processed for a rendering tile. Where the binning stage generates (hierarchies of) bounding boxes, e.g. for packets, a rendering tile and/or region of the render output may be compared to the bounding boxes to determine the, e.g. packets, that need to be processed for the rendering tile and/or region in question.

(Correspondingly, the rendering stage in an embodiment should, and in an embodiment does, comprise an initial process of using the binning data structure(s) generated by the binning stage to identify geometry, e.g. packets, to be processed for rendering tiles.)

Once the geometry (e.g. primitives or packets) to be rendered for a rendering tile has been identified, then the tile can be rendered.

The rendering processing that is performed for a tile can be any suitable and desired rendering processing that may be performed by a graphics processor and a graphics processing pipeline. Thus this may comprise, for example, rasterising primitives to fragments and fragment shading the fragments, and/or performing ray tracing processes, etc..

Other arrangements would, of course, be possible.

The technology described herein relates in particular to the situation where one or more clip planes have been defined for a render output, such that primitives to be processed for the render output could need to be clipped against one or more clip planes.

The render output that is being generated and for which one or more clip planes are defined can be any suitable and desired render output that the graphics processing being performed can be subdivided into (and, e.g., that is identifiable (identified) as a distinct and separate (render) output of the overall graphics processing being performed).

In an embodiment, the render output corresponds to a subset of the processing for producing an overall output, such as an output frame (e.g. to be displayed). Thus the render output is in an embodiment one of a sequence of plural render outputs that together serve for generating an output frame or sequence of output frames. In an embodiment, the render output comprises a (single) draw call.

(The overall render output that is being generated can be any suitable and desired output that a graphics processor and a graphics processing pipeline may be used to generate. In an embodiment the (overall) render output is an image (frame) for display, but it can be any other form of graphics processing output, such as graphics textures in a render-to-texture operation, etc., that a graphics processor and graphics processing pipeline may produce, as desired.)

The clip planes defined for a render output in this regard (and that will correspondingly be considered and if necessary used when processing a primitive) can be any suitable and desired clip planes that may be defined for a render output.

Thus the clip planes that are considered in the technology described herein may comprise one or more user defined clip planes and/or one or more view frustum/view port clip planes, such as near and far planes and (minimum and maximum) X and Y view port “edge” clip planes. The clip planes can be defined in any suitable and desired manner, for example, and in an embodiment, in the normal manner for the graphics processor and graphics processing system (and graphics API) in question.

Thus a (and each) user-defined clip plane that is defined for a render output is in an embodiment defined by defining for each vertex defined for the render output in question, the distance from that vertex to the user-defined clip plane in question.

Thus, in an embodiment, each vertex that is defined for the render output being generated has a respective user-defined clip plane “clip distance” defined for and associated with it for each user-defined clip plane that is defined for the render output, indicating the distance from the vertex to the user-defined clip plane in question.

(The clip distance from a vertex to a given user-defined clip plane may be, for example, and in an embodiment, determined and defined as part of the vertex shading process for the vertex in question: the vertex shading will generate and output as part of the vertex shaded data for a vertex, a clip distance for (to) each user-defined clip plane.)

Other (non-user defined) clip planes, such as screen space and view port (e.g. near and far and/or X and Y “edge”) clip planes, can correspondingly be defined in the normal manner for such clip planes in the graphics processor and graphics processing system (and graphics API) in question.

The clipping process that a primitive undergoes in the technology described herein can comprise any suitable and desired clipping process. It is in an embodiment performed based on and in accordance with the normal clipping process for the graphics processing pipeline and graphics processing system in question.

In an embodiment, the clipping process will operate to test the primitive against the clip planes defined for the render output, and, where appropriate, clip the primitive against the clip plane(s), e.g., and in an embodiment, such that when at least part of a primitive to be rendered falls behind a clip plane, the at least part of the primitive to be rendered that falls behind the clip plane is clipped to the clip plane.

(Correspondingly, in an embodiment, where the clipping process determines that a primitive should be entirely culled (“clipped away”) as a result of clipping against a clip plane(s) defined for the render output, the clipping process culls the primitive from further processing.)

In an embodiment, the clipping process operates to test the primitive against one or more of the clip planes defined for the render output, and generates zero or more new vertices (and zero or more new primitives) corresponding to and for the primitive as a result of any clipping that the primitive undergoes.

In the technology described herein, the clipping process generates position attributes for a (and for each) new vertex that is generated for a primitive as a result of the clipping of the primitive.

The position attribute(s) that are generated by the clipping process for a (and each) new vertex can comprise any suitable and desired position attributes for the vertex.

In an embodiment, the position attribute(s) that are generated by the clipping process for a (and each) new vertex comprise barycentric information (attributes), such as barycentric coordinates and/or barycentric coefficients, for the new vertex (in an embodiment relative to and using/based on the positions of the vertices originally defined for the primitive), and/or a clip space position (coordinates) for the vertex.

In an embodiment, the position attribute(s) that are generated by the clipping process for a (and each) new vertex comprise at least barycentric information (attributes), such as barycentric coordinates and/or barycentric coefficients, for the new vertex. In an embodiment, the clipping process also generates a clip space position (coordinates) for the vertex.

In an embodiment, the clipping process only generates position attribute(s), for the new vertices that are generated as a result of the clipping (and does not generate any non-position attributes for any new vertices that are generated as a result of the clipping).

In an embodiment, the clipping process for a (and each) new vertex generates only barycentric information (i.e. barycentric coordinates and/or barycentric coefficients) for the new vertex, or only barycentric information and a clip space position (coordinates) for the vertex.

In an embodiment, the clipping process generates a clip space position (coordinates), and/or (and in an embodiment and) barycentric coordinates ((in an embodiment) indicating the relative coordinates of the new vertex within the barycentric coordinate system for the original input primitive from which the new vertex was generated), for a (and each) new vertex generated as a result of the clipping process.

Thus, in an embodiment, the technology described herein comprises generating only one or more position attributes (but no non-position attributes) for the new vertices that are generated for a primitive as a result of the clipping process (and in an embodiment only barycentric information (e.g. coordinates and/or co-efficients), or only both barycentric information and clip space positions (coordinates), for each new vertex).

The clipping process only generating position attributes for any new vertices that are generated for a primitive as a result of the clipping process allows a more simplified clipping process (and, e.g., clip shader program) to be used for the clipping process (as it does not need to, for example, take into account the possibility that different draw calls, for example, may have different numbers and/or types of vertex attributes (varyings) associated with them and needing to be used for them). It also correspondingly means that a common clipping process (e.g. a common clip shader program) can be used for all draw calls (shared between draw calls), irrespective of the actual number of vertex attributes (varyings) that may be used and required for a particular draw call.

It also allows the amount of data that may be produced by the clipping process (e.g. the clip shader) for every new vertex to be known (and to be constrained and to be relatively small (as compared, e.g., to if all attributes, including non-position attributes, were being generated for the new vertices by the clipping process)), thereby, for example, limiting any overhead and memory bandwidth increase for the clipping process.

In an embodiment, the clipping process simply (and only) generates and outputs any new vertices (their appropriate attributes) that are required, with the original vertices for the primitive otherwise being stored, for example before the primitive undergoes the clipping process.

However, the clipping process, as well as generating any required new vertices (and their appropriate attributes), could also output any of the original vertices (and their appropriate attributes) that are still required for the primitive following the clipping process, if desired. In this case, the clipping process in an embodiment outputs appropriate position attributes only for any original vertex that is still required for a primitive.

In an embodiment, the clipping process supports more than one (e.g. two) process for determining barycentric information for vertices of a clipped primitive, and is, e.g., and in an embodiment, operable to select one of the plural barycentric information determination processes to use for a given primitive that is to undergo a clipping process, in an embodiment based on one or more properties of the primitive, such as, and in an embodiment, a size of the primitive.

The barycentric information determination processes may differ, for example, and in an embodiment, in how they determine the barycentric information for a vertex for a primitive that is undergoing the clipping process, and/or in the type of barycentric information that is generated for a vertex for a primitive, as desired.

The clipping processing for a primitive can be performed by any suitable and desired element (circuit) of the graphics processor. For example, the graphics processor may have a (substantially) fixed function unit (circuit) that is provided and used for this purpose.

In an embodiment, the clipping process for a primitive is performed by executing an appropriate (shader) program or programs (a “clip” shader or shaders) for the primitive in question. Such a “clip shader” may be, and is in an embodiment, executed by an appropriate programable processing unit (execution engine) of a programable processing core (shader core) of the graphics processor.

The clipping processing of primitives that are to undergo a clipping process for a render output is in an embodiment configured and performed such that plural primitives can, and in an embodiment do, undergo their clipping processing in parallel.

Correspondingly, in an embodiment, the clipping processing for primitives can be and is in an embodiment started without the need to wait for the clipping processing for a preceding primitive to be completed.

It would be possible simply to have every primitive for a render output undergo a clipping process (in the manner of the technology described herein).

However, in an embodiment, it is first determined for a (and for each) primitive to be processed for the render output being generated, whether the primitive should undergo a clipping process as part of its processing for the render output, with the clipping process then only being performing for the primitive when (if) it is determined that the primitive should undergo a clipping process as part of its processing for the render output.

In this case, it can be determined whether a primitive should undergo (be subjected to) a clipping process for a render output in any suitable and desired manner. This determination is in an embodiment done in an appropriately conservative manner, i.e. such that it will only be determined that a primitive should not undergo a clipping process for the render output where that can be determined with certainty.

In an embodiment, this determination comprises determining whether the primitive could be clipped by a clip plane defined for the render output. This test can be performed in any suitable and desired manner, for example, and in an embodiment, in accordance with the normal manner for determining whether a primitive could be clipped by a clip plane in the graphics processor and graphics processing system in question.

Thus, in the case of user defined clip planes, it is in an embodiment determined whether a primitive could be clipped by a user defined clip plane defined for the render output by considering and using the distances to the user-defined clip plane defined for and associated with the vertices of the primitive in question, and in an embodiment using the signs of the distances to the user-defined clip plane defined for and associated with the vertices of the primitive in question.

In an embodiment, where a primitive can be culled from further processing on the basis of a user-defined clip plane, that is done.

In the case of “view frustum” clip planes, such as near and far clip planes, and (minimum and maximum) X and Y view port (edge) clip planes, then again it can be determined whether a primitive could be clipped by any of those clip planes in any suitable and desired manner, such as, and in an embodiment, in accordance with the usual manner for doing such a determination for the graphics processor and graphics processing system in question.

At least in the case of the X and Y view port edge clip planes (if defined for a render output), this “could be clipped” test, in an embodiment uses and considers a “guard band” around the defined view port edges (around the clip planes defining the view port edges). In other words, rather than testing the primitive against the actual defined view port edge clip planes to determine if the primitive could be clipped by those clip planes, the primitive is tested against corresponding “clip plane” edges that are set a particular margin (a particular guard band) outside the actual view port edges. Such use of a guard band around the view port edges will reduce the likelihood of a primitive needing to be clipped in relation to the view port edges.

Again, in the case of view frustum/view port clip planes, in the case that it can be determined at this stage that a primitive can be culled from further processing on the basis of any of those clip planes, the primitive is in an embodiment culled from further processing on that basis.

In an embodiment, as well as determining whether a primitive could be clipped by a clip plane defined for the render output (so as to thereby determine whether the primitive should undergo a clipping process as part of its processing for the render output being generated), a primitive is also determined as needing to undergo a clipping process (in an embodiment even if there are no clip planes defined for the render output) in the case where the primitive is very large (exceeds a particular, in an embodiment selected, in an embodiment predetermined, threshold primitive size).

In an embodiment, a primitive is also or instead (and in an embodiment also) determined as needing to undergo a clipping process in the case where the primitive intersects both the near and the far plane (which can be determined in any suitable and desired manner), and the depth range (between the near and far planes) is below a particular, in an embodiment selected, in an embodiment predetermined, threshold value (to assess this, a suitable conservative estimate of the depth range can be made). This may help to handle primitives where the primitive intersects both the near and the far plane, but the depth range is zero.

It would be possible in this regard simply to determine on the basis of any of these tests whether a primitive should undergo a clipping process, and once one of these tests to indicate that the primitive should undergo a clipping process is met, simply determine that the primitive should undergo the clipping process at that point (and in one embodiment this is what is done).

However, in an embodiment, it is tested for each of the clipping planes defined for the render output whether the primitive could be clipped by that clip plane, and a count is maintained of how many of the clip planes defined for the render output the primitive could be clipped by. Thus, for example, and in an embodiment, when determining whether a primitive should undergo a clipping process for the render output, the primitive is in an embodiment tested against each of the view frustum clip planes and each of the user defined clip planes (if any) for the render output, and the number of clip planes that the primitive could be clipped by is determined (and tracked).

The determination of whether a primitive should undergo a clipping process for a render output can be performed by any suitable and desired element or component (circuit) of the graphics processor. For example, this may be done by execution of an appropriate (shader) program by a programmable processing unit (circuit) (execution engine) of the graphics processor.

In one embodiment, the graphics processor comprises a, in an embodiment dedicated, fixed function unit (circuit) that performs some or all of the determination of whether a primitive should undergo a clipping process for a render output.

It will be appreciated in this regard that the determination of whether a primitive should undergo a clipping process for a render output should comprise any necessary operations and tests for making that determination, but should not and will not include performing the actual clipping process itself for a primitive.

Thus this determination may, and in an embodiment does, determine, as discussed above, whether a primitive could be intersected by a clip plane (and as such need to undergo a clipping process), but the determination should not and in an embodiment does not determine any results of that potential intersection of the primitive by a clip plane (such as determining any additional vertices as a result of that intersection). Rather the determination of whether a primitive should undergo a clipping process for a render output should, and in an embodiment does, simply and solely determine that there could potentially be an intersection of a primitive with a clip plane, without determining, for example, any effect of that intersection.

The clipping process for a primitive (and any prior determination that the primitive should undergo the clipping process) can be performed at any suitable and desired stage in the graphics processing pipeline (prior to the rendering stage), and correspondingly be triggered and implemented at any suitable and desired stage of the graphics processing pipeline (prior to the rendering stage).

In an embodiment, these processes can be, and are in an embodiment, performed at and as part of the binning process (the binning stage) of the graphics processor and graphics processing pipeline.

In an embodiment, the binning process (the binning stage) of the graphics processor and graphics processing pipeline performs a determination of whether a primitive should undergo a clipping process for a render output (and thereafter performs the binning process for the primitive in question accordingly).

In an embodiment, in this case, when it is determined that a primitive should undergo a clipping process as part of its processing for the render output, an effect of clipping the primitive against clip planes defined for the render output is estimated (e.g., and in an embodiment, and as will be discussed further below, in terms of how many vertices and/or primitives could result for the primitive as a result of any clipping of the primitive against clip planes defined for the render output), and the binning stage/process then processes the primitive for inclusion in one or more (binning) data structures for identifying geometry to be processed for respective rendering tiles of the render output being generated based on the estimated effect of clipping of the primitive against clip planes defined for the render output (the binning process/stage then “bins” the primitive and generates the appropriate binning data structures based on and using the estimated effect of clipping on the primitive).

The clipping process for the primitive is in an embodiment then performed thereafter (and the rendering stage/process in an embodiment then uses the (binning) data structures generated by the binning stage/process and the result of the clipping process for the primitive for processing the primitive for the render output).

In these arrangements, the estimating of an effect of the (potential) clipping of a primitive against clip planes defined for a render output can be performed in any suitable and desired manner.

In an embodiment, the estimating of the effect of clipping of a primitive against clip planes defined for a render output comprises estimating a number of vertices that could result (need to be processed) (that there could be) for the primitive as a result of the clipping of the primitive against clip planes defined for the render output in question.

The estimating of the effect of the clipping process on a primitive (e.g. of the number of vertices that could result as a result of the clipping process for a primitive) is in an embodiment performed in an appropriately conservative manner. Thus the estimating process is in an embodiment configured and operates such that it cannot produce an underestimate of the effect of the clipping process on a primitive (e.g. in terms of the number of vertices that could result as a result of the clipping process for a primitive) (is configured such that, if the estimated effect of the clipping process on/for a primitive is in error, the estimate will be an erroneous overestimate (and not an underestimate) of the effect of the clipping process on the primitive).

In an embodiment a “worst case” estimate is determined. For example, and in an embodiment, a worst case estimate of the number of vertices that could result for a primitive as a result of clipping is in an embodiment estimated.

In an embodiment, the estimate is based on the number of clip planes that are defined for the render output (and in an embodiment on the number of those clip planes that it is determined that the primitive could be intersected by (where that is determined)).

The Applicants have recognised in this regard that the number of vertices and primitives that could result for a primitive as a result of clipping will, at least in certain circumstances, depend on the number of clip planes that a primitive intersects (and so should actually be clipped against).

In particular, at least in the case of triangular primitives (triangles), intersecting a clip plane will result in (at most) two vertices that need to be processed for a triangle (as the intersection will produce two new vertices, one at each intersection point, but at least one (and possibly two) of the original vertices will no longer be used as a result of the clipping).

Thus, for triangles at least, and assuming that any vertices generated from the intersection of clip planes that are no longer needed are discarded (as part of the clipping process), a worst case estimate of the result of clipping can be that each intersected clip plane will generate one more vertex (over and above the original (three) vertices for the triangle).

Correspondingly, for triangles at least, a worst case estimate of the result of clipping can be that each intersected clip plane will generate one more triangle (over and above the original triangle).

Thus, at least in the case of triangular primitives, when clipping against N clip planes, at least in the case where any vertices generated from the intersection of clip planes that are no longer needed are discarded (as part of the clipping process) (and in an embodiment that is done), a conservative estimate of the number of vertices and primitives that could result from the clipping process is that each clip plane produces one extra vertex (so 3+N vertices in total as a result of the clipping process), and one extra triangle (so 1+N triangles in total). Thus, for example, with 6 view frustum planes and 8 user clip planes, the theoretical worst case result of the clipping process will be 17 vertices and 15 triangles.

It would be possible in this regard simply to base the estimate of the number of vertices or primitives on the maximum number of clip planes defined for a render output when it is determined that a primitive needs to undergo a clipping process for a render output (and irrespective of the number of the clip planes for the render output that the primitive may actually (potentially) be clipped by) (and in one embodiment this is what is done).

In an embodiment, where it is determined, as discussed above, for each of the clip plates defined for a render output, whether a primitive could (potentially) be clipped by the clip plane (a count of the number of potentially “clipping” clip planes is determined), then the estimate of the number of vertices and primitives that could result for a primitive as a result of clipping of the primitive against clip planes defined from a render output is based on and set in accordance with the number of clip planes that it was determined the primitive could be clipped by for the render output.

As discussed above, the binning process will use an appropriate bounding box for a primitive for the binning process (e.g., and in an embodiment, to determine which primitive/packet lists the primitive should be included in, and/or for inclusion as a bounding box in a bounding box based binning data structure).

In an embodiment, rather than using the bounding box for a primitive as it will be after the primitive has undergone the clipping process, a bounding box that is determined without the primitive needing to undergo the clipping process is used for the primitive for this purpose (i.e. rather than determining the actual bounding box for the primitive after it has undergone the clipping process, an “estimated” bounding box for the “clipped” primitive is used for the binning process for a primitive that is to undergo the clipping process).

In one embodiment, a bounding box that is based on (and corresponds to) the original primitive (the “unclipped” version of the primitive) (that is based on the original (initially-defined) vertices for the primitive (that is to undergo the clipping process)) is used by and for the binning process for a primitive that is to undergo a clipping process.

In an embodiment, the bounding box that is used for a primitive that is to undergo the clipping process for the binning process can also, and in an embodiment does also, take account of a clip plane (and in an embodiment of one or more of the clip planes) defined for the render output.

The Applicants have recognised in this regard that a clipped primitive should not extend outside the clip planes defined for a render output, such that it will be an appropriately conservative estimate of the bounding box for a primitive if the bounding box is constrained to not extend outside a clip plane defined for the render output.

Thus, in an embodiment, the bounding box that is used for a primitive that is to undergo the clipping process for the binning process is based on a bounding box for (based on the vertices for) the originally defined (unclipped) primitive, and one or more of the clip planes defined for the render output (and in an embodiment constrained to be within one or more of the clip planes defined for the render output).

The binning process/stage can include a primitive in an appropriate binning data structure or structures, based on the estimated effect of the clipping of the primitive against clip planes defined for the render output, in any suitable and desired manner.

The binning operation in an embodiment takes account of, and is based on, an estimated number of vertices that could result for a primitive as a result of the clipping process for that primitive.

In an embodiment the binning process generates the binning data structures based on the estimate of the effect of any clipping of the primitive against clip planes defined for the render output, and in an embodiment taking account of, and based on, an estimated number of vertices that could result for a primitive as a result of the clipping process for that primitive.

In an embodiment, the binning process includes (allocates) (appropriate) entries in the binning data structures that it generates (and, e.g., and in an embodiment, allocates storage space for those entries), based on the estimate of the effect of any clipping of a primitive against clip planes defined for the render output, and in an embodiment taking account of, and based on, an estimated number of vertices that could result for a primitive as a result of the clipping process for that primitive (that it is estimated will result from the primitive as a result of the clipping process).

The binning data structure entries that are allocated/included for a primitive that is to undergo a clipping process are in an embodiment in the form of “placeholder” entries (as the clipping process will not yet actually have been performed for the primitive (prior to the binning process), and so the “true” data (values) for those entries will not yet be known).

This operation may, and in an embodiment does, depend upon the nature of the binning data structures that the binning process generates (is configured to generate).

In the case where the binning process generates lists of primitives and/or packets to be processed for respective regions of a render output, then in an embodiment, the binning process operates to add (include) (placeholder) primitives and/or packets to respective primitive/packet lists based on the estimated effect of the clipping of the primitive against clip planes defined for the render output (and using an appropriate bounding box for the primitive that is to undergo the clipping process, as discussed above).

Thus in this case, the binning process in an embodiment adds as many (placeholder) primitives/packets to the primitive/packet list(s) for a primitive that is to undergo the clipping process as would result according to the estimated effect of the clipping of the primitive against clip planes defined for the render output.

Thus in this case, it is in an embodiment estimated how many primitives and/or vertices could result for the primitive that is to undergo the clipping process as a result of the clipping of the primitive, and then that number of primitives and/or vertices is in an embodiment included (as placeholders) in a primitive list or lists by the binning process when “binning” the primitive that is to undergo the clipping process.

In the case where the binning process generates bounding box data structures (and in an embodiment hierarchies of bounding boxes) (for use then to determine which packets/primitives need to be processed for a respective region of the render output being generated), then in an embodiment, the binning process in an embodiment includes in the appropriate binning data structure(s) an appropriate bounding box or bounding boxes for a primitive that is to undergo the clipping process (in an embodiment determined as discussed above) and (placeholder) entries based on an estimated number of primitives/vertices (and/or for attribute(s) for those vertices) that could result from the clipping process.

In an embodiment, where the binning process operates to generate respective (primitive) packets that each store data for a set of one or more primitives (and in an embodiment for a set of plural primitives) to be rendered, the binning process operates to generate such packets for a primitive that is to undergo a clipping process for a render output based on the estimate of the effect of any clipping of the primitive against clip planes defined for the render output, and in an embodiment taking account of, and based on, an estimated number of vertices and/or primitives that could result for the primitive as a result of the clipping process for the primitive.

In an embodiment the binning process includes (adds) appropriate (placeholder) entries in a (primitive) packet for the primitives, and/or vertices, that it is estimated could result from a primitive as a result of the clipping process.

Thus in in an embodiment, it is estimated how many primitives and/or vertices could result for a primitive as a result of the clipping of the primitive, and then (placeholder) entries (storage space) for that number of primitives and/or vertices and/or for attributes for that number of vertices are included in (allocated for) a (primitive) packet or packets by the binning process when “binning” the primitive that is to undergo a clipping process.

Thus, where the (primitive) packets generated by the binning process store one or more attributes, such as positions, for a set of (in an embodiment plural) vertices for the primitives that a packet relates to, in the case of a primitive that is to undergo a clipping process, the binning process in an embodiment includes (adds) appropriate (placeholder) entries (allocates appropriate space) for storing the desired (position) attributes for vertices that may result from the clipping process in a (primitive) packet for the primitive, in an embodiment based on the number of vertices that it is estimated there could be for the primitive as a result of the clipping process.

In an embodiment, the binning process also sets aside (allocates) appropriate entries/space for other primitive data that may need to be included in the binning data structure (e.g. a primitive packet for the primitive that is to undergo the clipping process), such as for indicating a bounding box for the primitive, one or more identifiers relating to the primitive, and for indicating the vertices of the primitive (e.g. for commands for indicating this information).

In an embodiment, an indication that a primitive is a “clipped” primitive, or an entry (space) for an indication that a primitive is a “clipped” primitive, is also included in a binning data structure(s) (e.g. packet) by the binning process for a primitive that is to undergo the clipping process.

Once a primitive that is to undergo a clipping process has been processed by the binning process (as discussed above), then clipping of the primitive should be, and is in an embodiment, performed (the primitive is subjected to a (the) clipping process). As discussed above, the clipping process is in an embodiment performed by executing a “clip shader” for the primitive.

The clipping processing for a primitive can be triggered in any suitable and desired manner. In an embodiment, the binning process triggers the clipping process for a primitive (once the primitive to undergo the clipping process has been processed for inclusion in a binning data structure(s) by the binning process). To do this, the binning process in an embodiment triggers the execution of an appropriate clip shader for the primitive.

The clipping process for primitives could be triggered (by the binning process) as and when primitives complete their binning processing, for example on a primitive-by-primitive basis. Alternatively, the operation could wait for all of the binning processing for the render output in question to be completed, with the clipping processing for all primitives for the render output that are to undergo the clipping process then being triggered. Other arrangements would, of course, be possible.

Once the clipping processing has been completed for a primitive, the primitive can be rendered.

In an embodiment, the clipping processing for all of the primitives that are to undergo a clipping process for the render output in question is completed before the rendering processing for the render output is begun.

The result of the clipping process for a primitive, such as any new vertices (and their (position) attributes), any of the original vertices (and their attributes), and/or any new primitives, can be conveyed to the rendering process in any suitable and desired manner. For example, this information could be provided as a separate data structure or structures to the rendering process.

In an embodiment, the result of the clipping process for a primitive is provided to the rendering process as part of and in the binning data structures that are provided to the rendering process.

Thus, in an embodiment, the result of the clipping process for a primitive is added to and included in a binning data structure or structures that has been generated by the binning process (and in an embodiment in a binning data structure or structures that the primitive that has undergone the binning process was included in by the binning process prior to undergoing the clipping process). In an embodiment this comprises (at least) including any and all new vertices (at least, and in an embodiment only, position attributes for those vertices) in the (appropriate) binning data structure or structures.

The information that is included in a binning data structure or structures to convey the result of the clipping process for a primitive to the rendering process may, and in an embodiment does, depend upon the nature of the binning data structures and the data that they store. For example, where the binning data structures comprise lists of primitives/packets to be processed for respective rendering tiles or sets of rendering tiles, the necessary information for any vertices that are a result of the clipping process for a primitive are in an embodiment appropriately included in those lists.

In the case where the binning data structures comprise bounding boxes, such as and in an embodiment hierarchies of bounding boxes, then again the result of the clipping processing is in an embodiment included in those data structures appropriately.

Thus, in the case where the bounding box data structures (include packets that) store attributes of vertices for primitives that they relate to, the (appropriate) attributes for any new vertices that are generated as a result of the clipping process for a primitive are in an embodiment included in the binning data structures accordingly.

Similarly, in the case where the bounding box data structures (include packets that) store attributes of vertices for primitives that they relate to, the (appropriate) attributes for any original vertices that are not discarded as a result of the clipping process for a primitive are in an embodiment included in the binning data structures accordingly.

As discussed above, in an embodiment, the binning process is configured to allocate (placeholder) entries in the binning data structures that it generates for a primitive that is to undergo a clipping process (based on an estimated effect of any clipping of the primitive in question). Thus in an embodiment, the result of the clipping processing for a primitive is included in a binning data structure by including the necessary clipping result data, such as position attributes for new vertices that are generated as a result of the clipping process, in the appropriate (placeholder) entries included (allocated) in the previously prepared binning data structures.

Thus, for example, and in an embodiment, where it is estimated that the clipping process could result in a given number of vertices for a primitive, the binning process will allocate an appropriate placeholder entry or entries in a binning data structure or structures for (one or more (position) attributes for) that estimated number of vertices, the clipping process will then be performed for the primitive, and the relevant data (position attributes) for the vertices needed for the primitive after the clipping process will be included in the previously allocated placeholder entries for the vertices (attributes) in the binning data structure(s).

The Applicants have further recognised in this regard that the estimate of the effect of the clipping process on a primitive, e.g. in terms of the number of vertices that may result as a result of the clipping process for the primitive, may overestimate the number of vertices that will result for a primitive as a result of the clipping process.

The Applicants have correspondingly recognised in this regard that where the binning process allocates placeholder entries in the binning data structures for data corresponding to the results of the clipping process based on an estimate of the effect of the clipping process for the primitive, and the estimate of the effect of the clipping process for a primitive turns out to be an overestimate of the number of vertices that was produced as a result of the clipping process for the primitive, then there will, in effect, be placeholder entries in the binning data structures for clipping process results (such as for position attributes for additional vertices) that are not in fact generated as a result of the clipping process. It would accordingly be desirable in this case to be able to indicate that those placeholder entries are “invalid” (do not contain valid clipping result data, such as additional vertex attribute data), so that the rendering process can “ignore” those placeholder entries in the binning data structures.

Thus, in an embodiment, any space ((placeholder) entries) allocated in a binning data structure for a primitive that is to undergo a clipping process that are not in fact needed to store data that results from the clipping process for a primitive are in an embodiment appropriately indicated as being invalid (as not containing any valid data) (as not to be used). This may be done in any suitable and desired manner, for example by setting an appropriate flag for the “invalid” (placeholder) entries. In an embodiment, this is done by setting the data values in the (placeholder) entries to “not a number” (NaN) (for the graphics processing system in question), so that the rendering processing can recognise that those entries do not contain valid data. Other arrangements would, of course, be possible.

Thus in an embodiment, when the clipping process generates position attributes (values)) for one or more new vertices for a primitive, it stores the data (the position attributes) for those vertices in (placeholder) entries (previously allocated space) in a (previously prepared) binning data structure.

Correspondingly, in an embodiment, the clipping process provides for (e.g. in) any (placeholder) entries (space) in a binning data structure for vertices (e.g. their attributes) for a primitive that is undergoing the clipping process that the clipping process determines are not in fact required for the primitive (for which the clipping process does not generate data), an indication that those entries in the binning data structure are not valid.

In an embodiment, the clipping process also updates (includes) in a binning data structure any other information that it is desirable to update/include for the primitive that has undergone the clipping process. For example, where the binning process allocates appropriate entries (space) for other information, such as a bounding box, and/or identifiers, etc., for a primitive that is to undergo a clipping process, that information can be, and is in an embodiment, appropriately populated in the binning data structure (e.g. packet) by the clipping process.

In an embodiment, the clipping process also adds an appropriate indication that the primitive has undergone a clipping process in the appropriate binning data structure or structures (where such an indication is not already present for the primitive).

In the case where it is other than (it is not) determined that a primitive should undergo a clipping process for the render output, then the primitive can be handled in the normal manner for the graphics processor and graphics processing pipeline being executed in question. For example, the primitive can be, and is in an embodiment, simply processed by the binning stage in the normal manner to be included in an appropriate binning data structure or structures, and then does not undergo any clipping process, but rather is subjected to rendering processing in the normal manner when the tiles for the render output are being rendered.

Once the binning processing and any clipping processing for primitives for a render output has been completed, then the rendering processing for the render output (for the primitives for the render output) can be, and is in an embodiment, performed.

The rendering processing can comprise any suitable and desired rendering processing that a graphics processing pipeline can perform.

The rendering will be performed on a tile by tile basis (as the graphics processor is executing a tile based graphics processing pipeline), and so, accordingly, the rendering process will, and in an embodiment does, use the binning data structures generated by the binning stage (and updated by the clipping processing where necessary) to identify geometry, e.g. packets/primitives, to be processed for a (and each) tile to be rendered, and then render the tile accordingly.

The rendering processing that is performed for a tile can be any suitable and desired rendering processing that may be performed by a graphics processor and a graphics processing pipeline. Thus this may comprise, for example, rasterising primitives to fragments and fragment shading the fragments, and/or performing ray tracing processes, etc..

The rendering processing can be, and is in an embodiment, performed in the normal manner for the graphics processor and graphics processing pipeline in question.

The rendering process in an embodiment generates appropriate rendered output data values (e.g. RGB or RGBA values) for a primitive and for the tile of the render output that is being rendered. The output rendered data may then be appropriately written out, e.g. to memory, for the render output in question.

As discussed above, in the technology described herein the rendering stage/process uses the position attributes generated by the clipping process for new vertices generated as a result of the clipping process for a primitive when determining the values of one or more non-position attributes when processing a primitive that underwent a clipping process for the render output. This can be done in any suitable and desired manner.

The non-position attributes for which data values are determined by the rendering process in this manner can be any suitable and desired non-position attributes for which the rendering process may generate values. In embodiments the non-position attributes comprise colours and/or transparency, but values for other non-position attributes could also or instead be determined, if desired.

In an embodiment, the rendering stage/process uses (and the rendering stage processing circuit is configured to use) both the position attributes generated by the clipping process for the new vertices generated as a result of the clipping process for the primitive, and one or more non-position attributes for the original vertices of the primitive that underwent the clipping process (which will have been defined for those original vertices), when determining the values of one or more non-position attributes when processing the primitive that underwent the clipping process for the render output.

Thus, for example, and in an embodiment, in order to determine a colour value when processing a primitive that underwent the clipping process for a render output, the rendering process will use the colour values for the original vertices of the primitive, together with the position attributes generated by the clipping process for the new vertices generated as a result of the clipping process for the primitive.

In one embodiment, the rendering stage/process uses (and the rendering stage processing circuit is configured to use) the non-position attribute values for the original vertices for the primitive that underwent the clipping process together with barycentric coordinates for the new vertices generated as a result of the clipping process when determining (to determine) the non-position attribute values for the primitive for the render output.

In an embodiment, the rendering stage/process uses (and the rendering stage processing circuit is configured to use) the position attributes (such as, and in an embodiment, barycentric coordinates) for the new vertices generated as a result of the clipping process to determine a set of barycentric coefficients for the primitive that underwent the clipping process, and then uses those barycentric coefficients (in an embodiment together with the non-position attribute values for the original vertices for the primitive that underwent the clipping process) when determining (to determine) the non-position attribute values for the primitive that underwent the clipping process for the render output.

The rendering process/stage can use the position attributes generated by the clipping process for the new vertices generated as a result of the clipping process for a primitive that underwent the clipping process when processing the primitive that underwent the clipping process at any suitable stage and point of the rendering process. For example, this may be done before, as part of, or after, rasterisation (where the rendering process includes a rasterisation process/stage).

In an embodiment, the rendering stage/process uses (and the rendering stage processing circuit is configured to use) the position attributes generated by the clipping process for the new vertices generated as a result of the clipping process for a primitive that underwent the clipping process (and, e.g., barycentric coefficients derived using those position attributes) when it is desired to determine (and for determining) the value(s) of non-position attribute(s) for sampling positions within the primitive that underwent the clipping process.

In an embodiment, the rendering stage/process uses (and the rendering stage processing circuit is configured to use) the position attributes generated by (as a result of) the clipping process for the new vertices generated as a result of the clipping process for a primitive that underwent the clipping process for interpolating (and to interpolate) the value(s) of non-position attribute(s) for sampling positions within the primitive that underwent the clipping process.

Such an interpolation process for determining the value of a non-position attribute at a sampling position within a primitive that underwent the clipping process can be performed using any suitable and desired element and unit of the graphics processor and the rendering stage. In an embodiment, the rendering stage includes an interpolation circuit (unit) that is configured to interpolate attribute values from, for example, and in an embodiment, known values of those attributes at particular, e.g., vertex, positions and an appropriate representation of the sampling position for which the interpolated value is required, for example, and in an embodiment, using an appropriate set of barycentric coefficients, for that purpose.

The rendering process could in this regard first determine the desired non-position attribute values for the new vertices generated as a result of the clipping process for a primitive (using the position attributes generated by the clipping processes for those new vertices and, in an embodiment, the non-position attributes for the original vertices for the primitive), and then use those determined non-position attributes for the new vertices when processing the primitive that underwent the clipping process for the render output (e.g., and in an embodiment, to derive interpolated values for those non-position attributes at sampling positions within the primitive that underwent the clipping process) (and in one embodiment that is what is done).

However, in an embodiment, rather than first determining the values of the non-position attributes for the new vertices generated for the primitive that underwent the clipping process, and then using those “new vertex” non-position attribute values to interpolate the non-position attribute values at a desired sampling position within a primitive that underwent the rendering process, the desired non-position attribute value for a sampling position within the primitive that underwent the clipping process is (directly) interpolated from the values for that non-position attribute for the original vertices for the primitive that underwent the clipping process (using the position attributes (and, e.g., barycentric coefficients derived using those position attributes) generated by the clipping process for the new vertices generated as a result of the clipping process for the primitive).

Thus, in an embodiment, the rendering stage/process (and the rendering stage processing circuit is configured to) interpolates a non-position attribute value for a sampling position within the primitive that underwent the clipping process directly from the values for that non-position attribute for the original vertices for the primitive that underwent the clipping process based on the position attributes generated by the clipping process for the new vertices generated as a result of the clipping process for the primitive.

Determining the desired non-position attribute values for a sampling position within the primitive that underwent the clipping process directly from the values for that non-position attribute(s) for the original vertices for the primitive that underwent the clipping process avoids the need, for example, to additionally initially derive and store those non-position attributes for the new vertices that are generated as a result of the clipping process. It also facilitates using existing attribute interpolation functionality of the rendering stage/process to also handle the generation of non-position attribute values for sampling positions within clipped primitives, and without the need to generate and store those non-position attribute values explicitly for new vertices that are generated as a result of clipping of a primitive.

Thus, in an embodiment, the rendering stage/process using the position attributes generated by the clipping process for the new vertices generated as a result of the clipping process for the primitive when determining the values of one or more non-position attributes when processing the primitive that underwent the clipping process is performed at and when a value for the non-position attribute in question falls to be determined for a sampling position within the clipped primitive, and in an embodiment when such a non-position attribute value falls to be determined for a sampling position within the clipped primitive when performing fragment processing (shading) for a fragment that the sampling position belongs to.

Correspondingly, in an embodiment, the rendering stage/process using the position attributes generated by the clipping process for the new vertices generated as a result of the clipping process for the primitive when determining the values of one or more non-position attributes when processing the primitive is performed at and triggered by a fragment processing (shading) stage/process of the rendering process/stage (i.e. when the value of a non-position attribute for a sampling position for a fragment being rendered for a clipped primitive falls to be determined during the fragment processing).

Thus, in an embodiment, the rendering process comprises a rasterisation process that rasterises primitives to be rendered to respective fragments each representing a set of one or more sampling positions that are covered at least in part by the primitive being rendered, followed by a fragment processing (shading) process that “shades” (that generates non-position attribute values, such as colour and transparency values for) fragments for primitives that are generated by the rasterisation stage (and that, in an embodiment, survive any potential fragment culling testing, such as depth or stencil testing), with the fragment processing then triggering the use of (and using) the position attributes generated by the clipping process for the new vertices generated as a result of the clipping process for a primitive that underwent the clipping process when determining (to determine) the values of non-position attribute(s) for (covered) sampling positions that a fragment represents.

It will be appreciated from the above that in embodiments of the technology described herein at least, the non-position attributes for the original vertices of the primitive that underwent the clipping process are provided to the rendering process (e.g. for the purposes of then interpolating from those values using the position attributes generated by the clipping process for new vertices generated as a result of the clipping process for a primitive).

This also facilitates more straightforwardly supporting the rendering processing where attribute values for a primitive are to be taken directly from an indicated (“provoking”) vertex of a primitive and used without any interpolation (such as in the case of “flat-shading” (flat-shaded attributes) in Vulkan and “nointerpolation” decoration in DirectX, for example) (and can avoid, for example, the clipping process needing to know and take account of which attributes may be “flat-shaded” (and to accordingly handle those attributes differently), and/or the creation of any intermediate attribute value that might or might not need to be interpolated).

Thus, in embodiments of the technology described herein at least, the non-position attributes for the original vertices of the primitive that underwent the clipping process are provided to the rendering stage/process, such that, for example, and in an embodiment, a “provoking” vertex attribute value to be used in the case of an attribute that is not to be interpolated when a primitive is rendered is directly available to the rendering stage/process and so can be used for that purpose.

Although the technology described herein has been described above with particular reference to the processing in respect of a given (single) primitive being considered for a render output, it will be appreciated that the processing in the manner of the technology described herein should be, and is in an embodiment, performed for plural primitives, and in an embodiment for each primitive of the primitives to be rendered for a render output.

Subject to the particular operation in the manner of the technology described herein in relation to the (potential) clipping of primitives, the graphics processor and graphics processing pipeline can otherwise operate in any suitable and desired manner, for example, and in an embodiment, in the normal manner for the graphics processor and graphics processing pipeline in question.

Correspondingly, as well as the particular elements, stages, circuits, etc., described above with particular reference to the operation in the manner of the technology described herein, the graphics processor and graphics processing pipeline may otherwise include any suitable and desired elements, circuits, processing stages, etc., that a graphics processor and graphics processing pipeline may normally comprise.

Thus, the graphics processor and graphics processing pipeline may, and in an embodiment does, also comprise any other suitable and desired processing stages (circuits) that a graphics processor and processing pipeline may contain, such as a depth (or depth and stencil) tester(s) (circuit(s)), a blender (blending circuit), a tile buffer or buffers, a write out unit (circuit), etc..

It will furthermore be appreciated that the graphics processor of the technology described herein may be part of an overall graphics processing system that includes, e.g., and in an embodiment, a host processor (e.g. CPU) that, e.g., executes applications that require (graphics) processing by the graphics processor. The host processor will send appropriate commands and data to the graphics processor to control it to perform graphics processing operations and to produce graphics processing output required by applications executing on the host processor. To facilitate this, the host processor should, and in an embodiment does, also execute a driver for the graphics processor. The host processor may also execute a compiler or compilers for compiling programs to be executed by (e.g., a programmable processing stage (shader) of the) graphics processor.

The graphics processor may also comprise, and/or be in communication with, one or more memories and/or memory devices that store the data described herein, and/or the output data generated by the graphics processor, and/or store software (e.g. programs) for performing the processes described herein. The graphics processor may also be in communication with a host microprocessor, and/or with a display for displaying images based on the data generated by the graphics processor.

The technology described herein can be used for all forms of output that a graphics processor and graphics processing pipeline may be used to generate. For example, the graphics processor may generate frames for display, render to texture outputs, etc.. The output data values from the processing are in an embodiment exported to external, e.g. main, memory, for storage and use, such as to a frame buffer for a display.

The technology described herein can be implemented in any suitable system, such as a suitably operable micro-processor based system. In some embodiments, the technology described herein is implemented in a computer and/or micro-processor based system.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and "means" of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

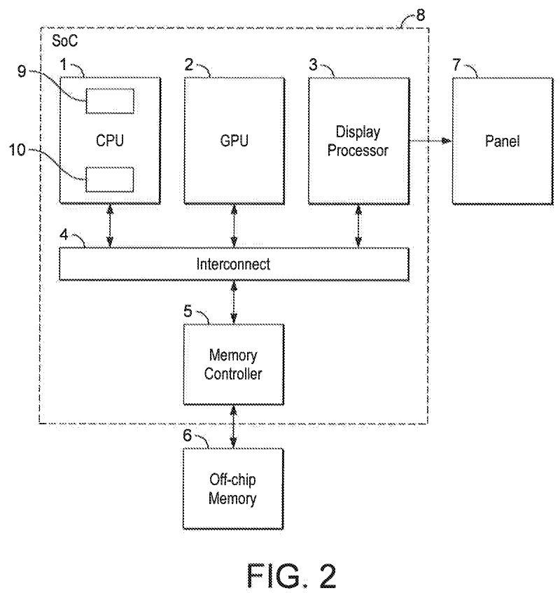

FIG. 2 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 2, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

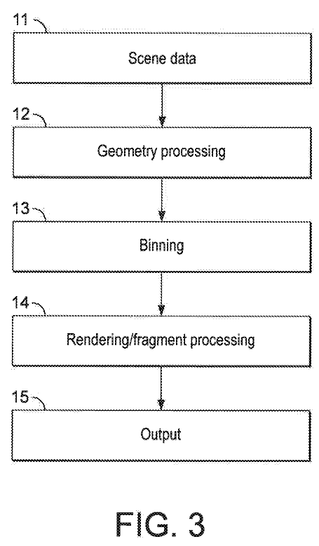

FIG. 3 shows schematically the processing sequence of the graphics processing pipeline executed by the graphics processor 2 when generating an output in the present embodiments.

FIG. 3 shows the main elements and pipeline stages. As will be appreciated by those skilled in the art there may be other elements of the graphics processor and processing pipeline that are not illustrated in FIG. 3. It should also be noted here that FIG. 3 is only schematic, and that, for example, in practice the shown pipeline stages may share significant hardware circuits, even though they are shown schematically as separate stages in FIG. 3. It will also be appreciated that each of the stages, elements and units, etc., of the processing pipeline as shown in FIG. 3 may, unless otherwise indicated, be implemented as desired and will accordingly comprise, e.g., appropriate circuitry, circuits and/or processing logic, etc., for performing the necessary operation and functions.

As shown in FIG. 3, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 3, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a "render to texture" output), or for deferred rendering, or for hybrid ray tracing, etc..

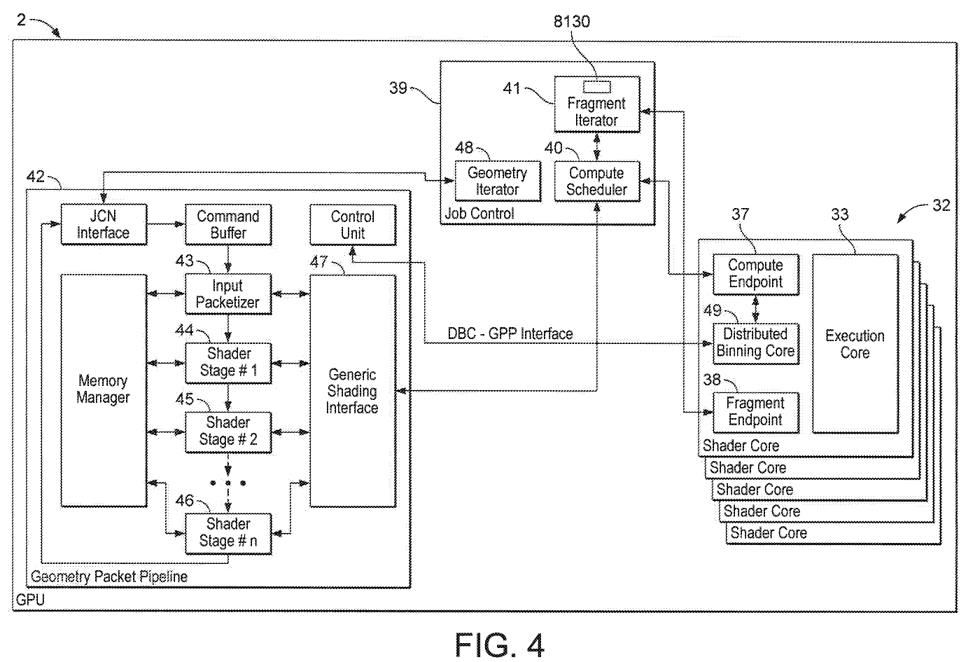

FIG. 4 shows an embodiment of a graphics processor (GPU) 2 that can execute a graphics processing pipeline of the form shown in FIG. 3, and that can be operated in the manner of the technology described herein.

As shown in FIG. 4, the graphics processor 2 comprises a plurality of processing (shader) cores 32 which are each operable to execute (shader) programs to perform processing operations. As shown in FIG. 4 each shader core 32 to facilitate this comprises a programmable execution unit (execution core) 33 that is operable to execute program instructions to perform processing operations.

In the present embodiments, the shader cores 32 are operable to execute both “compute” shader programs (to perform so-called compute shading) and fragment shader operations. Thus as shown in FIG. 4, each shader core 32 comprises an appropriate compute endpoint 37 and fragment endpoint 38 that act as the control interface for performing compute shading and fragment processing, respectively, and that will, for example, and in an embodiment, trigger the execution core 33 to execute the appropriate compute shading or fragment shading tasks, as required.

As shown in FIG. 4, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 4, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 4, the geometry packet pipeline 42 comprises an input packetizer 43 that can trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 4, the geometry packet pipeline 42 has an appropriate interface 47 to the compute scheduler 40 of the job control unit 39, via which it can control and trigger the performance of appropriate geometry shading operations by the shader cores 32.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 4 is configured to perform rendering in a tile-based manner (as discussed above). To facilitate this, as shown in FIG. 4, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

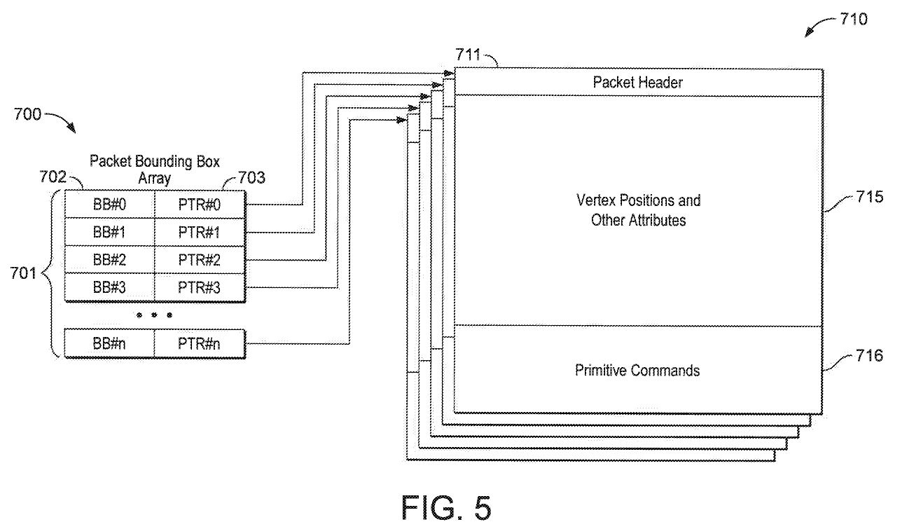

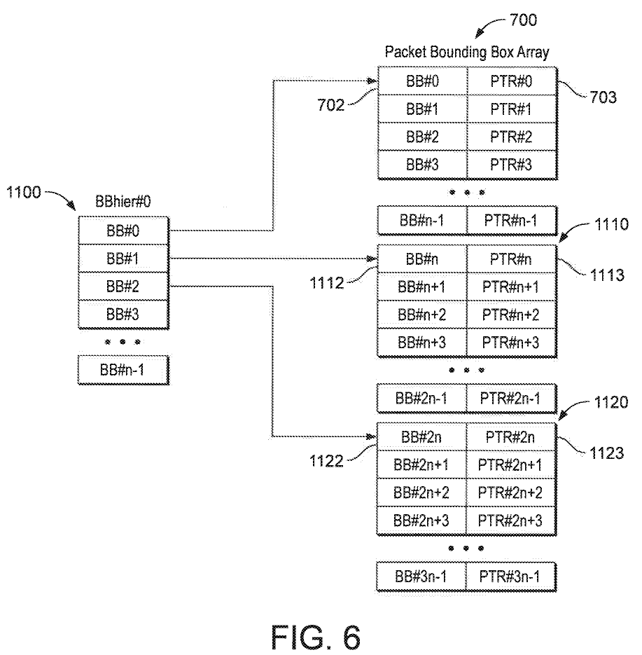

FIGS. 5 and 6, show, by way of example, a bounding box hierarchy binning data structure that may be generated in the present embodiments.

As shown in FIG. 5, the lowest level of the bounding box hierarchy comprises a packet bounding box array 700 that includes a number of entries 701 that each include a respective pointer 703 pointing to a respective packet 710 in memory, and a bounding box (bounding box information) 702 for the packet in question.

FIG. 5 also shows the memory layout and content for an exemplary packet 710 that may have been generated. As illustrated in FIG. 5, in the present embodiments, each packet 710 may include header information 711 and body information comprising vertex attribute data (such as positions and other attributes) 715 for the vertices that the packet contains, and a set of primitive commands 716 that may indicate for each primitive the packet relates to (stores) one or more of: one or more identifiers for the primitive; a bounding box for the primitive; and the vertices for the primitive (e.g. where the vertices and attributes for the primitive are located in the packet).

Other arrangements for a packet would, of course, be possible.

As shown in FIG. 6 one or more further bounding box hierarchy levels are also generated.

As illustrated in FIG. 6, a bounding box hierarchy array 1100 may be maintained, with each entry of the array comprising a pointer pointing to an array defining bounding boxes for a respective level of the bounding box hierarchy. As illustrated in FIG. 6, in this embodiment, the first entry of the bounding box hierarchy array 1100 points to the lowest level packet array 700 shown in FIG. 5.

A higher level of the bounding box hierarchy may be generated by iterating through the packet array 700 and generating from the packet bounding boxes 702, bounding boxes for groups of, e.g. two, four, eight (or another number), packets. As illustrated in FIG. 6, these (larger) bounding boxes may be stored in entries of higher-level array 1110, wherein each entry of the array 1110 comprises a respective, “higher level” bounding box 1112, and pointers 1113 pointing to the packet array 700 entries for the packet bounding boxes from which the “higher level” bounding box was generated.

Further levels of the bounding box hierarchy may be generated in an analogous manner. For example, FIG. 6 shows a higher-still level of the bounding box hierarchy generated by iterating through array 1110 and generating from the bounding boxes 1112, larger bounding boxes, which are stored in entries of array 1120, wherein each entry of the array 1120 comprises a respective, higher level bounding box 1122, and pointers 1123 pointing to the corresponding next lower level array 1110 entries. Further levels of the bounding box hierarchy may be generated up to a “highest” level which may comprise a single bounding box that encompasses all primitives of all packets, e.g. for the draw call/render output in question.

When using this data structure to identify primitive packets that should be processed for a rendering tile, the tile will first be tested against the higher level bounding boxes 1122 to determine respective groups of primitive packets that (potentially) need to be processed for the tile. Then the tile will be tested against the respective individual packet bounding boxes in the appropriate lower level 700 data structure to identify those primitive packets that should be processed for the tile.

The technology described herein and the present embodiments relate in particular to the handling of clip planes and clipping when performing tile-based graphics processing. As discussed above, in graphics processing, it is typically possible to define both view frustum clip planes, and one or more user-defined clip planes, that the rendering process then has to take account of, and e.g., and in an embodiment, clip primitives to be rendered against.

(In the case of a user-defined clip plane, the vertex shading that is part of the geometry processing will, inter alia, also generate for each vertex defined for the render output a “clip distance”, representing the distance from the vertex to the user-defined clip plane in question.)

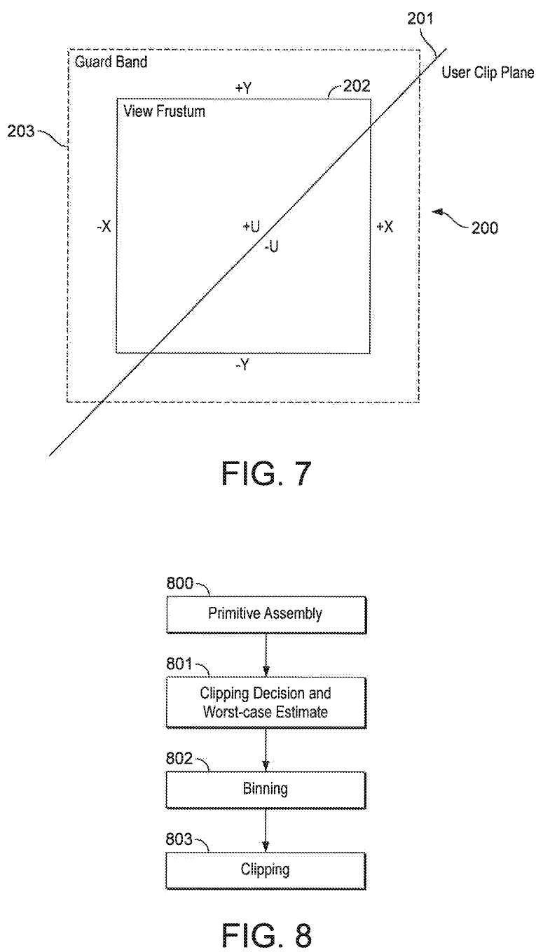

FIG. 7 shows an example of clip planes for a render output 200 to be generated. FIG. 7 shows one user defined clip plane 201 crossing the render output, together with X/Y view frustum clip planes 202 and a guard band 203 defined around the view frustum X/Y clip planes. (The Z axis is not shown in this Example.)

In the present embodiments, the (potential) clipping of primitives is handled by determining whether a primitive should undergo a clipping process, and, if so, then estimating the effect of clipping on the primitive, and binning the primitive based on the estimated effect of (potential) clipping of the primitive. Then, once the binning process has been performed for the primitive, the primitive undergoes the actual clipping process.

FIG. 8 illustrates this, and shows that after a primitive has been assembled (step 800), it is then determined whether the primitive needs to undergo a clipping process, and if so, an estimate (and in the present embodiment a worst case estimate) of the effect of clipping on the primitive is determined (step 801).

The primitive is then subjected to the binning process based on the (worst case) estimate of the effect of clipping on the primitive (step 802).

Once the binning process has been completed, the primitive can then undergo the (actual) clipping process, to determine the (true) effect of any clipping on the primitive (step 803).

In the present embodiment, the “clipping handling” operation shown in FIG. 8 is performed by the distributed binning cores 49 as part of the binning operation that they perform (step 13 in FIG. 3).

However, other arrangements would be possible, such as some of the processing shown in FIG. 8 being performed, for example, as part of the geometry processing (step 12 in FIG. 3), and/or as part of the rendering/fragment processing (step 14 in FIG. 3).

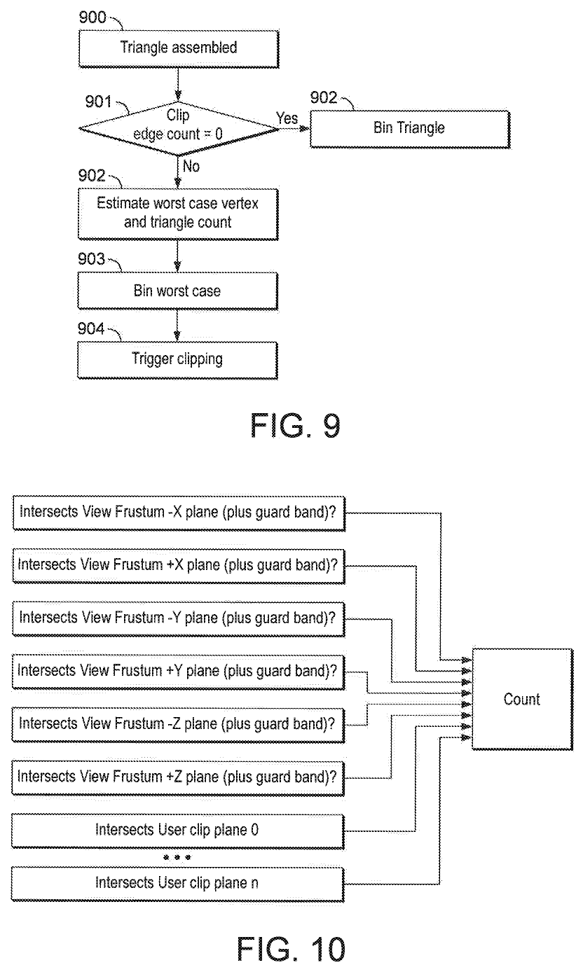

FIGS. 9 and 10 show the clipping handling operation of FIG. 8 in more detail.

As shown in FIG. 9, in the present embodiments, once a triangle (primitive) has been assembled (step 900), it is then determined, as shown in FIG. 10, how many clip planes/edges the primitive (triangle) intersects (step 901).

This test may be performed in any suitable and desired manner. For example, the distributed binning cores 49 could include appropriate fixed function circuits (not shown) for performing a (basic) intersection test to determine whether a primitive (triangle) could intersect a clip plane for the render output being generated or not.

In the case where it is determined that the triangle does not intersect any of the clip planes defined for a render output, then, as shown in FIG. 9, the triangle can simply be “binned” (undergo the binning process) in the normal manner (step 902).

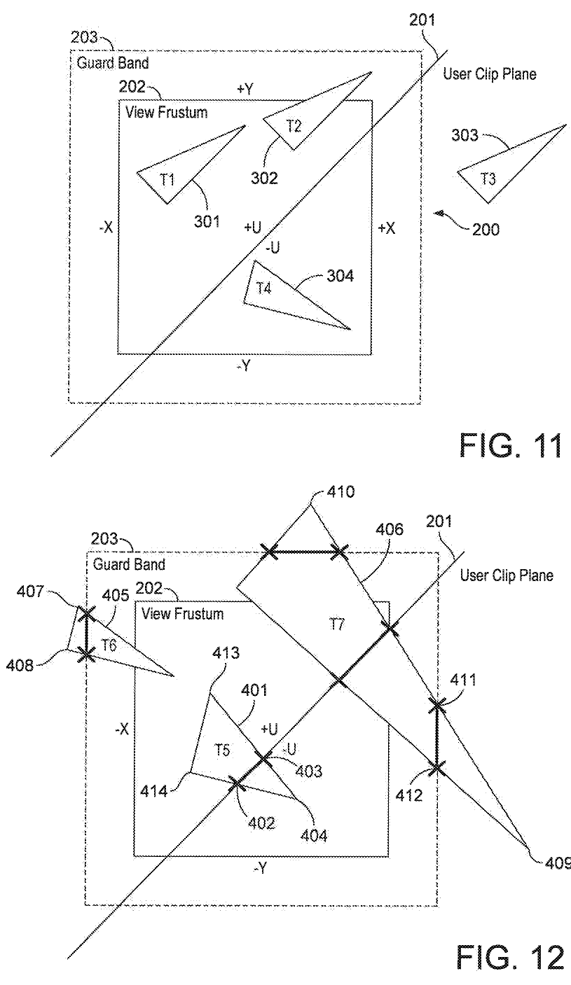

FIG. 11 shows some exemplary triangular primitives for the render output 200 shown in FIG. 7 that will be determined as not needing to undergo a clipping process.

Triangle T1 301 lies entirely within the view frustum clip planes 202 and on the visible side of the user clip plane 201, and so no clipping will be required.

Triangle T2 302 does intersect the view frustum 202, but is inside the guard band 203 (and on the visible side of the user clip plane 201), and so again no clipping is required for that triangle.

Triangle T3 303 lies entirely outside of the view frustum guard band, and so should be discarded without undergoing any clipping.

Triangle T4 304 lies entirely on the non-visible (outside) the user clip plane 201, and so again can be discarded (on the basis of the user defined clip plane) without undergoing any clipping.

On the other hand, in the case where a primitive (triangle) is determined to intersect at least one clip plane for the render output, it is determined that the triangle will need to undergo the clipping process, and in that case, an estimate of the worst case vertex and triangle count that could arise as a result of clipping of the triangle is determined (step 902).

(As discussed above, when a primitive, e.g. triangle, to be rendered is intersected by a clip plane, then that is handled by generating additional vertices at the intersection points, and then (if necessary) processing those vertices and primitives (triangles) containing those vertices accordingly. Thus when a primitive needs to be clipped against a clip plane, there may be new vertices and primitives generated for the clipped primitive. This may be in addition to or instead of (some or all of) the original vertices for the primitive.)

In the present embodiments, the estimated worst case number of vertices and of primitives that could be generated for the primitive as a result of the clipping of the primitive against clip planes defined for the render output is based on the number of clip planes defined for the render output that it is determined that the primitive could be intersected by.

FIG. 12 shows some exemplary primitives for the exemplary render output 200 that will need to undergo a clipping process (and the “worst case” estimate of the effect of that clipping process).

Triangle T5 401 is entirely within the view frustum but intersects the user clip plane. That triangle will accordingly need clipping against the user clip plane 201.

A conservative estimate of the result of clipping of the triangle T5 401 is that clipping could result in four vertices (3+1) and two triangles (1+1) to be processed.

Triangle T6 405 intersects one side of the view frustum guard band and so should undergo a clipping process. Again, a conservative estimate of the effect of that clipping is that it will result in four vertices (3+1) and two triangles (1+1) to be processed.

Triangle T7 406 intersects two edges of the view frustum guard band and the user clip plane 201 and so again should undergo a clipping process. The conservative estimate for this triangle is that the clipping process will result in six vertices (3+3) and four triangles (1+3) needing to be processed.

The binning process then operates to include the triangle that is to undergo the clipping process in appropriate binning data structure(s) based on the estimated vertex and triangle count (step 903).

To perform the binning process for a primitive (triangle) that is to undergo the clipping process, the binning process will, as discussed above, use an appropriate bounding box for the triangle that is to undergo the clipping process. In the present embodiments, an appropriately conservative estimate of a bounding box for a triangle that is to undergo the clipping process is used when binning the triangle.

In the present embodiments, the bounding box for the original triangle (without any clipping) is used for the binning process.

However, it would also be possible to use a better estimate of the bounding box for a potentially clipped triangle if desired. For example, the bounding box could be constrained to not lie outside one or more of the clip planes defined for the render output (as it will be known that a triangle cannot extend outside a clip plane defined for a render output, and so the bounding box for the triangle can correspondingly be constrained to be within some or all of the clip planes, if desired).

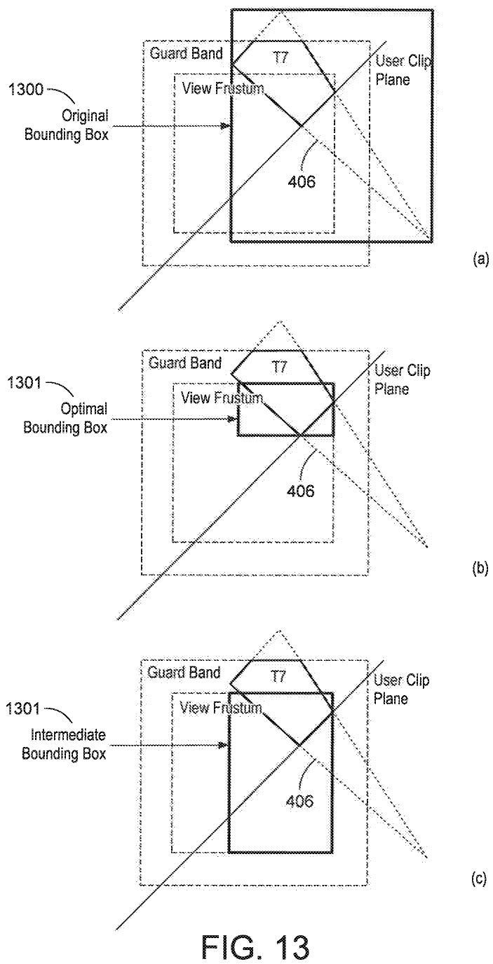

FIG. 13 illustrates this, and shows potential bounding boxes that could be used for the binning process for the triangle T7 406 shown in FIG. 12.

FIG. 13A shows the original bounding box 1300 for the triangle T7 406.

FIG. 13C shows a “better” estimate, “intermediate” bounding box 1301 for the triangle T7 406 in which the bounding box is constrained to lie within the view frustum.

FIG. 13B shows for comparison purposes the optimal bounding box 1302 for the triangle T7 406 based on the actual positions of the clipped vertices for the triangle T7 406 that result from the clipping process (in this example).

As discussed above, in the present embodiments, the binning process generates appropriate (primitive) packets that include for a primitive that is included in a packet, vertex attribute data for the vertices of the primitive, and one or more primitive commands that indicate, e.g. an identifier(s) for the primitive, a bounding box for the primitive, the vertices for the primitive, etc., together with an appropriate hierarchy of bounding box data structures.

In the case of a primitive that is to undergo a clipping process, the binning process will also include in the (primitive) packet for the primitive that is to undergo the clipping process, an indication that the primitive is a “clipped” primitive (this will then allow the rendering process (for example) to identify that the primitive underwent the clipping process, and that, accordingly, there may be vertices generated as a result of the clipping process to process for the primitive), and of the type of clipping process for the primitive (where the graphics processing system supports performing more than one type of clipping process for a primitive), and an indication of the number of vertices and/or primitives that could be generated by clipping for the primitive in question (based on the estimated number of vertices that could result (need to be processed) for the primitive as a result of the clipping process for that primitive).

The binning process also includes (adds) (appropriate) placeholder entries in the primitive packet (and allocates storage space for those placeholder entries) for attributes for vertices that may result from the clipping process for the primitive, based on the estimated number of vertices that could result (need to be processed) for the primitive as a result of the clipping process for that primitive.

The binning process also includes in the packet an indication of the location of those placeholder entries in the primitive packet (for example in the form of an offset to the location of the placeholder entries for the “clipped” vertices for the primitive). (This will then allow the location of the entries for (attributes for) any new vertices generated as a result of clipping for a primitive in the primitive packet to be determined).

The binning process will also operate to, where necessary, update any higher level bounding boxes in the binning data structures that it is generating based on the bounding box that is used for the primitive that is to undergo the clipping process.

Once the primitive (triangle) that is to undergo the clipping process has been binned, the actual clipping process for the primitive is then triggered and performed (step 904).

In the present embodiments, the clipping process operates to test the primitive against the clip planes defined for the render output, and, where appropriate, clip the primitive against the clip plane(s), such that when part of a primitive to be rendered falls behind a clip plane, the part of the primitive to be rendered that falls behind the clip plane is clipped to the clip plane, and zero or more new vertices, and zero or more new primitives, corresponding to and for the primitive being “clipped”, will be generated.

The clipping process also generates position attributes in the form of barycentric information (e.g. barycentric coordinates and/or coefficients) for a (and each) new vertex that is generated as a result of the clipping of a primitive. In the present embodiments, it also generates a clip space position (coordinates) for a (and each) new vertex that is generated as a result of the clipping of a primitive.

(The generation of other attributes (e.g. non-position attributes) for any new vertices generated as a result of the clipping of a primitive is deferred until later in the sequence of graphics processing (and in the present embodiments is done as part of the rendering process).)

In the present embodiments, the clipping process for a primitive is performed by executing an appropriate (shader) program or programs (a “clip” shader or shaders) for the primitive by a shader core of the graphics processor.

The clip shader execution for a primitive that is to undergo the clipping process is triggered by the distributed binning core 49 sending an appropriate shading request to the compute endpoint 37.

In the present embodiments, the clipping process operates to update the previously prepared packet that includes the primitive that has been clipped based on the results of the clipping process (to include the clipping result data).

Thus the clipping process will include (in the appropriate placeholder entries) in the packet that includes the primitive that has been clipped an appropriate set of position attributes for each new vertex for that primitive that is generated as a result of the clipping process for the primitive.

(In the present embodiments, the bounding box that is included in a primitive packet for a primitive that has undergone the clipping process is the bounding box to be used for the primitive for the binning process originally (and so is not an “updated” bounding box that takes account of any result of the clipping process for the primitive (although that would be possible, if desired)).

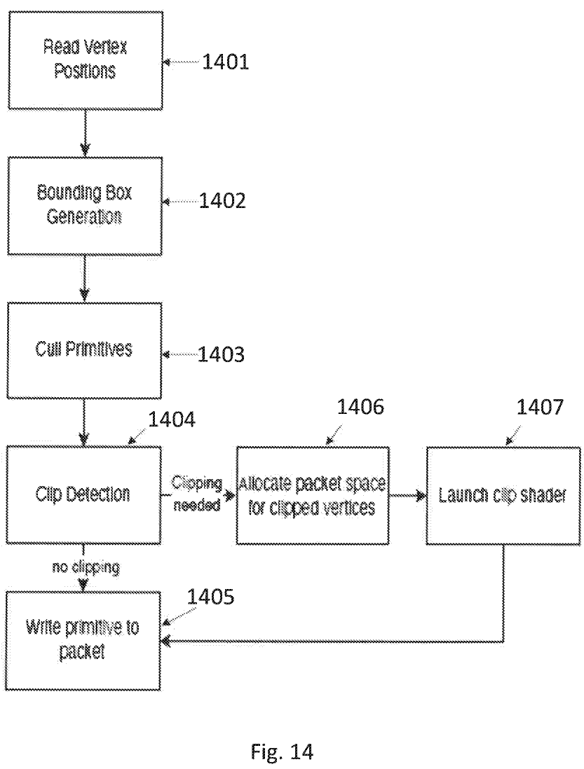

FIG. 14 shows this generation of packets for providing to the rendering process in the present embodiments in more detail.

As shown in FIG. 14, when generating a packet (when encoding primitives into a packet), the positions of the (initially defined/original) vertices for a primitive being added to the packet will first be read (step 1401).

Those vertex positions will then be used to generate an appropriate bounding box for the primitive (step 1402). This may comprise, for example, and in an embodiment, translating the vertex positions from clip space into screen space and the determining the bounding box of the primitive in screen space (min _x, min_y), (max_x, max_y).

It may then be determined whether the primitive can simply be culled from further processing (step 1403). Such culling could comprise, for example, back facing culling, screen space culling, small primitive culling, etc.. This could also comprise culling based on user-defined or view frustum clip planes (where it can be determined on the basis of a clip plane that a primitive can be culled entirely).

When a primitive is not culled, it is then determined whether the primitive should undergo a clipping process as part of its processing for the render output being generated (as discussed above) (step 1404).

As shown in FIG. 14, in the case where a primitive does not need to undergo a clipping process, then the primitive and its vertices can simply be written into the packet accordingly (step 1405). In this case the (positions and other attributes) for the original (initially-defined) vertices for the primitive are written into the vertex positions and attributes portion 715 of the packet, and primitive command(s) for the primitive are written into the primitive commands portion 716 of the packet.

When a primitive is to undergo a clipping process, then again the (positions and other attributes) for the original (initially-defined) vertices for the primitive are written into the vertex positions and attributes portion 715 of the packet, and primitive command(s) for the primitive are written into the primitive commands portion 716 of the packet (as discussed above, in this case, the primitive commands for the primitive will indicate that the primitive is a “clipped” primitive (and the clipping process for the primitive, where appropriate), and an indication of the location of the “clipped” vertices for the primitive in the packet and how many clipped vertices there may be for the primitive).

In addition, appropriate space (placeholder entries) are allocated in a “clipped” vertex positions and barycentrics portion 1602 of the packet for the (position attributes for the) (potential) (new) clipped vertices that may be generated for the primitive as a result of the clipping process (as discussed above) (step 1406).

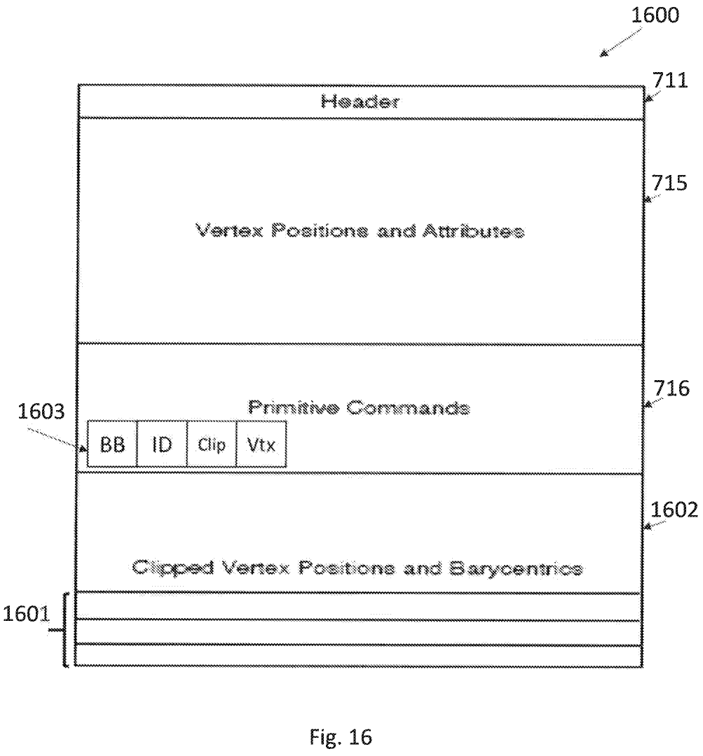

FIG. 16 illustrates this. As shown in FIG. 16, and as discussed above, the primitive packets 1600 that are provided to the rendering process in the present embodiments include a vertex positions and attributes portion 715 that stores the vertex positions and attributes for the initially defined vertices for the primitives that the packet relates to, a primitive commands portion 716 that stores primitive commands that indicate appropriate primitive information for each primitive that is stored in the packets, and a clipped vertex positions and barycentrics portion 1602 at the end of the packet that stores clip space positions and barycentric information for vertices that are generated as a result of the clipping process for a primitive.

The packet 1600 also includes a header 711 which will indicate where the different portions of the packet can be found (e.g. offsets to where the vertex positions/attributes can be found, where the primitive commands are located, and where the clipped vertex positions and barycentrics are located). The header may also describe groups of primitives and their location within the primitive commands (in the case where the primitives of a packet are divided into respective groups within the packet).

FIG. 16 further shows the inclusion of placeholder entries 1601 in the “clipped vertex positions and barycentrics” portion 1602 that is added to the end of the packet 1600 for storing these attributes for a primitive that is to undergo a clipping process.

As shown in FIG. 16, appropriate entries 1603 for the required primitive commands for a primitive that is to undergo the clipping process are included in the primitive commands portion 716 of the packet.

In the case where the clipping process supports different types of clipping operation (for example in respect of the determination of the barycentric coordinates for clipped vertices), it may also be determined at this point which type of clipping is needed, e.g. is to be used for the primitive (e.g. based on the size of the primitive), and the type of clipping performed (where there is more than one possible clipping process that could be performed for a primitive) may also be indicated within the packet 1600.

The primitive commands portion 716 of the packet will in the present embodiments also store, for a primitive that is to undergo the clipping process, the original bounding box (that was determined before any clipping took place), the location of the clipped vertices in the packet, and the (worst case maximum) number of primitives and/or vertices that the clipping process could generate for the primitive.

The primitive is then subjected to the clipping process (step 1407, FIG. 14) (which in the present embodiment is performed by the execution of an appropriate clip shader program).

Once the clipping process has been completed for the primitive, the appropriate information (the clipping result) is written into the allocated space (placeholder entries) 1601 in the packet (step 1405).

In the present embodiments, this comprises writing the appropriate position attributes for any clipped vertices generated for the primitive, which, as discussed above, in the present embodiments comprise barycentric information (in an embodiment barycentric coordinates), or barycentric information and clip space positions, for the vertices, into the allocated space (placeholder entries) 1601 in the packet for those vertices.

To do this, the clipping process may use the information in the packet indicating where the position attributes for the new, “clipped” vertices for the primitive should be stored in the packet (where the placeholder entries in the packet for those vertices are located in the packet), and then write the appropriate position attributes for the clipped vertices generated for the primitive to the placeholder entries accordingly. In this way, the clipping process can output “clipped” vertices to the appropriate placeholder entries in the packet without the need to know the structure of the packet, or the need to decode and then modify and then re-encode any part of the packet.

Other arrangements would, of course, be possible.

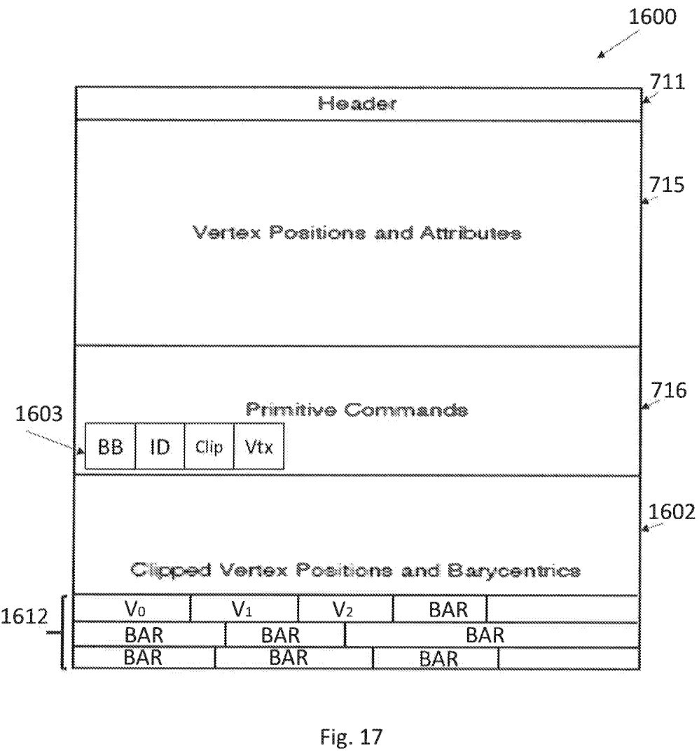

FIG. 17 illustrates this operation of the clipping process updating the relevant primitive packet 1600 for a primitive after it has undergone the clipping process. FIG. 16 shows the primitive packet 1600 of FIG. 16, but in this case, as shown in FIG. 17, the relevant (actual) vertex position attributes 1612 for the vertices resulting from the clipping process for the primitive have been updated in the previously allocated “placeholder” entries 1601 for that information for the primitive that underwent the clipping process.

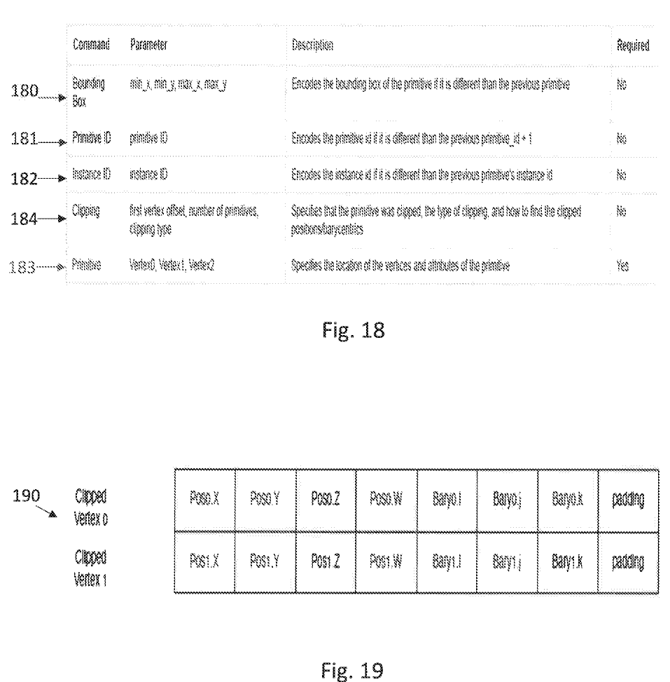

FIG. 18 shows an exemplary set of primitive commands, some or all of which may be included in the primitive command part 716 of a packet for a respective primitive.

As shown in FIG. 18, for a primitive, there may be a command 180 specifying the bounding box of the primitive (e.g. if it is different than the bounding box of the previous primitive in the packet), one or both of a primitive ID 181 and an instance ID 182 (e.g. where they differ from the previous primitive), and a primitive command 183 that specifies the location of the vertices and attributes of the primitive in the vertex positions and attributes portion 715 of the packet.

As shown in FIG. 18, it is also possible, in accordance with the technology described herein, to include a “clipping” command 184 for a primitive that indicates that the primitive underwent a clipping process (as discussed herein).

In the present embodiments, as shown in FIG. 18, this “clipping” command indicates that the primitive underwent a clipping process, the type of clipping that was performed (where there are plural different types of clipping that can be performed for a primitive), and the location of the positions and barycentrics for the clipped primitive in the clipped vertex positions and barycentrics portion 1602 of the packet (for example, in the form of an appropriate offset to the first vertex for the clipped primitive in the clipped vertex position and barycentrics portion 1602 of the packet). It also indicates the maximum number of primitives that the clipping process could generate for the primitive.

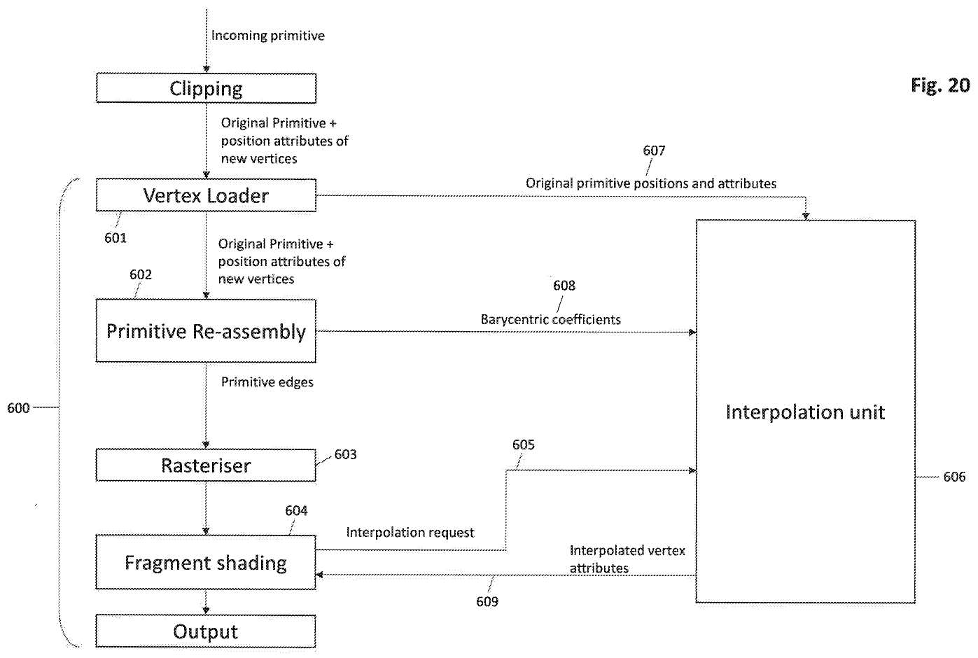

FIG. 19 shows an exemplary entry for new vertices that are generated as a result of the clipping process for a primitive that will accordingly be stored in the clipped vertex positions and barycentrics portion 1602 of a packet as a result of the clipping process for a primitive. As shown in FIG. 19, in the present embodiments, for each new vertex 190 that is generated as a result of the clipping process for a primitive, a set of positions (coordinates) in clip space are stored for the vertex, together with a corresponding set of barycentric coordinates.

The Applicants have further recognised in this regard that because the binning process allocates “placeholder” entries for vertices (vertex position attributes) based on a worst case estimate of the effect of clipping on a primitive, there may in fact be allocated placeholder entries for which a vertex (vertex position attribute data) does not result from the clipping process for a primitive.

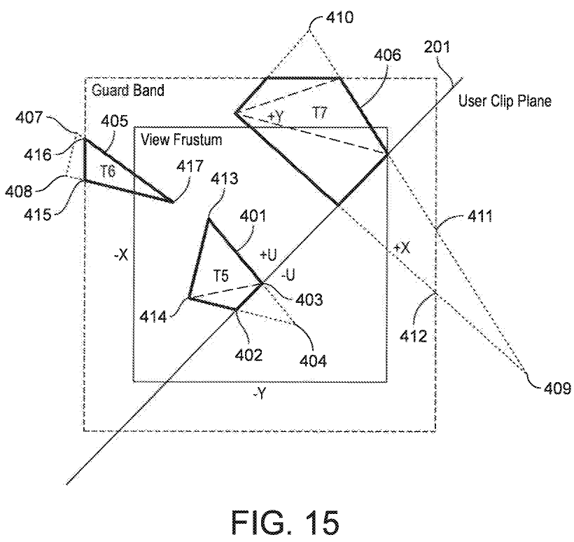

FIG. 15 illustrates this, and shows the actual clipping “result” for the primitives shown in FIG. 12.

As shown in FIG. 15, the clipping process will determine that for the triangle T5 401, four vertices (being two original vertices 413, 414 and two new vertices 402, 403) and two triangles will need to be processed for the triangle as a result of the clipping process.

For the triangle T6 405 the clipping against the view frustum guard band results in two of the original vertices 407, 408 not being needed and so only three vertices (two new vertices 415, 416 as a result of the clipping and one of the original vertices 417) are needed and there will be one triangle to process as a result of the clipping process.

For the triangle T7 406, when the clipping is actually performed, it will determine that two of the original vertices 409, 410 and two of the (potential) new vertices 411, 412 are not needed for the triangle, so five vertices and three triangles need to be processed for the triangle.

To allow for this, in the present embodiments the clipping process sets any placeholder entries in the packets for vertices/vertex attributes which the clipping process does not in fact result in (generate (any data for)) to “not a number” (NaN) (for the graphics processing system in question), so that the rendering processing can recognise that those entries do not contain valid data.

Once the clipping processing has been completed for a primitive (and, e.g., the packet has been correspondingly updated), the primitive can be rendered.

In an embodiment, the clipping processing for all of the primitives that are to undergo a clipping process for the render output in question is completed (and the packets correspondingly updated) before the rendering processing for the render output is begun.

In the present embodiments, the rendering/fragment processing is triggered and controlled by the fragment iterator 41 issuing appropriate fragment shading (rendering) tasks to the fragment endpoints 38 of the shader cores, with the fragment endpoints then triggering appropriate fragment shading etc., on the execution cores, accordingly.

The tasks will indicate an appropriate set of one or more tiles to be rendered by the shader core in question, together with an indication of the rendering/fragment processing that is to be performed for the tiles. The fragment endpoint 38 will then use the packets and binning data structures generated by the distributed binning cores (as updated by any clipping processing) to identify the packets and primitives to be processed for a tile that they are processing, and perform appropriate rendering/fragment processing for the primitives in question for the tile in question.

In the present embodiments the rendering process operates to process the primitives in a packet in turn.

Thus the rendering process operates to identify a primitive in a packet and the relevant vertices (their attributes) for the primitive in the packet and to then process (render the primitive) accordingly.

Thus, the rendering process will determine for a primitive in a packet whether the primitive has an associated indication that the primitive has undergone a clipping process, and, if so, then retrieve the position attributes for the vertices that resulted from the clipping process for the primitive from the packet (e.g., and in an embodiment, based on an indication of the location of the vertices (their attributes) in the packet), and process the primitive accordingly.

The rendering process will first assemble a primitive from its vertices and then processes the primitive accordingly.

Thus, in the case of a primitive that has undergone a clipping process, the vertices resulting from the clipping process for the primitive will be assembled into an appropriate primitive according to a given primitive configuration (topology). In an embodiment the rendering process always uses a triangle fan configuration for primitives that have undergone a clipping process.

Correspondingly, in the case of a primitive that has undergone a clipping process, the rendering process in an embodiment assembles the primitive for processing based on an indication in the packet of how many primitives the clipping process generated.

The rendering/fragment processing that is performed for primitives and for a tile can comprise any suitable and desired rendering/fragment processing that can be performed, such as rasterising primitives to fragments and then performing fragment shading for the fragments, and/or performing ray tracing operations, etc..

Once a shader core has processed a tile, that tile will be written out to memory and the shader core will process the next tile (if any) that it is to process, and so on. This will be continued until the render output in question has been entirely generated.

This process will then be repeated for the next render output, and so on.

FIG. 20 shows the rendering process in the present embodiments in more detail.

As shown in FIG. 20, and as discussed above, following the clipping process, for any primitive that has undergone the clipping process, the vertices for the original primitive (and their attributes) together with position attributes generated by the clipping process for any new vertices generated as a result of the clipping process, will be stored (in a packet).

Then, for the rendering process, that vertex data for primitives (within packets) is read by a vertex loader 601 that will fetch in the vertex data for a particular primitive and pass this to a primitive (re-)assembly stage 602. (Thus it will be appreciated that the data output from the clipping process is not passed directly to the vertex loader 601 but is instead transferred via (external) memory.)

In order to process a clipped primitive, the vertex loader 601 will thus fetch in the original primitive’s vertex positions and attributes from which the clipped primitive was generated, as well as the position attributes of the vertices for the clipped primitive itself.

In the present embodiments, as discussed above, the position attributes that are provided from the clipping process for vertices of a clipped primitive may comprise barycentric coordinates of the new vertices (relative to the original primitive), or both barycentric coordinates of the new vertices and clip space positions (coordinates) for the new vertices. (In the case where the clipping process does not generate clip space positions for the new vertices for a clipped primitive itself, then those clip space positions can instead be determined using the original vertex positions and the barycentric coordinates of the new vertices relative to the original primitive.)

The original vertex positions and attributes for the clipped primitive, together with the position attributes of the new vertices are then, as shown in FIG. 20, provided to a primitive re-assembly stage 602 that will use the original primitive’s vertex positions (i.e. in clip space) to determine a set of barycentric coefficients for the original primitive.

The primitive re-assembly stage 602 will further use the clip space positions for the clipped primitive (which, as discussed above, may be provided either as part of the position attributes generated by the clipping process, or may be determined by the primitive re-assembly process from the barycentric coordinates for the new vertices provided by the clipping process and the vertex positions of the original vertices for the clipped primitive) to generate a set of edge equations for the clipped primitive.

The (edge equations for the) clipped primitive is (are) then passed to a rasteriser 603 for rasterisation into respective fragments, which rasterisation will be performed using the set of edge equations, e.g. in the normal manner for such edge-based rasterisation stage 604. For any fragments resulting from the rasterisation process, fragment shading 604 is performed to further process the fragments to produce the desired output values.

(Thus, in the present embodiments, the graphics processing pipeline performs rasterisation-based rendering and so the primitives are rasterised into fragments and the fragments are then subjected to fragment shading to produce the desired output.)

In the present embodiments, the fragment shading 604 is operable to trigger interpolation of the non-position attributes defined for the original primitive to the associated sampling positions within a clipped primitive, so as to provide desired non-position attribute values (e.g. colours) for sampling positions within a clipped primitive.

The fragment shading 604 may thus issue an interpolation request 605 to an interpolation unit 606 within the graphics processor that is operable to perform the required interpolation of the non-position attributes.

To facilitate this, as shown in FIG. 20, the vertex loader 601 is operable to provide the interpolation unit 606 with the positions and other, non-position attributes 607, for the original vertices for a clipped primitive. The interpolation unit 606 will then suitably interpolate those attributes 607 to the coordinates within the original primitive corresponding to the respective sampling positions for which the fragment shading is being performed.

To do this, the interpolation unit 606 will need to convert sampling positions defined within the (cartesian) screen space to positions inside the original primitive (for which the non-position attributes are defined).

In the present embodiment, this is achieved by the primitive re-assembly stage 602 generating and providing barycentric coefficients 608 for the original primitive to the interpolation unit 606.

When the interpolation unit 606 receives an interpolation request 605 from the fragment shading, the interpolation unit 604 can then use the barycentric coefficients 608 output by the primitive re-assembly 602 to interpolate the non-position vertex attributes defined for the original primitive to the sampling positions associated with the fragments for which the interpolation request 605 was generated. The interpolation unit 606 will then return suitably interpolated vertex attributes 609 to the fragment shading 604.

It would also or instead be possible for the primitive re-assembly process to determine barycentric coefficients for the new primitive(s) created as a result of the clipping process for a primitive and to provide those barycentric coefficients also or instead to the interpolation unit 606 for the interpolation unit to then use when deriving the interpolated vertex attributes for sampling positions within a clipped primitive, if desired.

In another embodiment, a set of barycentric coefficients generated by the primitive (re-)assembly stage 603 for a clipped primitive is used together with the relative barycentric coordinates for the clipped primitive to determine a transformed set of barycentric coefficients for the clipped primitive that has an equivalent effect to the barycentric coefficients for the original primitive and that can accordingly be provided to and used by the interpolation unit 606 to convert sampling positions defined in the (cartesian) screen/clip space to positions inside the original primitive, and thus used to determine non-position vertex attributes (varyings) for sampling positions within the clipped primitive using the non-position attributes of the original vertices of the primitive.

Thus, in this case, the rendering process will, for example, use the clip space positions for the new vertices of the clipped primitive (which clip space positions may be provided by the clipping process or determined using the position values from the original primitive and the barycentric coordinates for the clipped primitive relative to the original primitive) to determine the edge equations and barycentric coefficients for the clipped primitive, and then use the clipped primitive’s barycentric coordinates and the calculated barycentric coefficients to generate a transformed set of barycentric coefficients with the same effect as the original primitive’s barycentric coefficients, and then provide the “transformed” set of barycentric coefficients to the interpolation unit 606 for use as the barycentric coefficients for the original primitive (to use when interpolating non-position attribute values for sampling positions within the clipped primitive from the non-position attributes of the original vertices of the clipped primitive).

Other arrangements would, of course, be possible.

In the case of a primitive that has not undergone the clipping process (a primitive for which no clipping is necessary), the rendering process can process that primitive in the normal manner, i.e. using the positions and non-position attributes for the vertices of the primitive and deriving appropriate barycentric coefficients for the primitive to thereby allow the interpolation unit to derive appropriate (non-position) attribute values for sampling positions within the primitive from the corresponding non-position attribute values for the vertices of the primitive.

In the above embodiments, the binning process generates binning data structures in the form of bounding box hierarchies and packets containing primitives to be processed. It would also be possible for the binning process to generate other forms of binning data structures, such as respective primitive lists for tiles, and/or for sets of plural tiles, of a render output. In the case of alternative binning data structures, those data structures should again be generated in the appropriate manner based on the, e.g. worst case, estimate of the effect of clipping of a primitive.

In an embodiment, as well as determining whether a primitive could be clipped by a clip plane defined for the render output (so as to thereby determine whether the primitive should undergo a clipping process as part of its processing for the render output being generated), a primitive is also determined as needing to undergo a clipping process in the case where the primitive exceeds a particular threshold primitive size and/or in the case where the primitive intersects both the near and the far plane (which can be determined in any suitable and desired manner), and the depth range (between the near and far planes) is below a particular, in an embodiment selected, in an embodiment predetermined, threshold value (to assess this, a suitable conservative estimate of the depth range can be made).

It can be seen from the above, that the technology described herein, in its embodiments at least, can provide a more efficient mechanism for handling the clipping of primitives in a graphics processing system. This is achieved, in the embodiments of the technology described herein at least, by the clipping process, when it generates one or more new vertices for the primitive, only generating position attributes for the new vertices that are generated as a result of the clipping process, with the rendering stage/process then using the position attributes generated by the clipping process for the new vertices generated as a result of the clipping process to determine the values of one or more non-position attributes when rendering sampling positions within the primitive that underwent the clipping process.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of operating a graphics processor when executing a tile-based graphics processing pipeline to generate a render output, the graphics processing pipeline being executed comprising:
a sequence of one or more geometry processing stages to perform geometry processing;
a binning stage that performs a binning process to generate data structures for identifying geometry to be processed for respective rendering tiles of a render output being generated;
a rendering stage for rendering tiles of a render output being generated;
the method comprising, when generating a render output in which primitives to be rendered can be clipped against a clip plane defined for the render output, for a primitive to be processed for the render output being generated and that is to undergo a clipping process as part of its processing for the render output:
performing a clipping process for the primitive; and
when the clipping process generates one or more new vertices for the primitive, the clipping process generating position attributes for the new vertices that are generated as a result of the clipping process;
and, thereafter:
the rendering stage using the position attributes generated by the clipping process for the new vertices generated as a result of the clipping process for the primitive when determining the values of one or more non-position attributes when processing the primitive that underwent the clipping process for the render output.

2. The method of claim 1 wherein the position attribute(s) that are generated by the clipping process for a new vertex comprise one or more of:
barycentric coordinates for the new vertex; and
a clip space position for the new vertex.

3. The method of claim 1, wherein the binning process triggers the clipping process for a primitive.

4. The method of claim 1, wherein the position attributes generated by the clipping process for the new vertices for a primitive are provided to the rendering process in a binning data structure that is provided to the rendering process.

5. The method of claim 1, wherein the clipping process for a primitive is performed by executing a graphics shader program that performs the clipping process for the primitive.

6. The method of claim 1, comprising:
determining whether a primitive should undergo a clipping process as part of its processing for the render output; and
when it is determined that the primitive should undergo a clipping process as part of its processing for the render output, performing a clipping process for the primitive.

7. The method of claim 1, wherein the values of one or more non-position attributes for the original vertices of the primitive that underwent the clipping process are provided to the rendering stage.

8. The method of claim 1, wherein the non-position attribute(s) for which values are determined by the rendering stage using the position attributes generated by the clipping process for new vertices generated as a result of the clipping process for a primitive comprises colour or transparency attribute(s).

9. The method of claim 1, wherein the rendering stage using the position attributes generated by the clipping process for the new vertices generated as a result of the clipping process for the primitive when determining the values of one or more non-position attributes when processing the primitive that underwent the clipping process, is performed when the value of a non-position attribute for a sampling position for a fragment being rendered for a clipped primitive falls to be determined during fragment processing.

10. The method of claim 1, wherein the rendering stage comprises:
a rasterisation stage that rasterises primitives to be rendered to respective fragments each representing a set of one or more sampling positions that are covered at least in part by the primitive being rendered, followed by a fragment processing stage that generates non-position attribute values for fragments for primitives that are generated by the rasterisation stage; and
the fragment processing stage triggers the using of the position attributes generated by the clipping process for the new vertices generated as a result of the clipping process for a primitive that underwent the clipping process when determining the values of one or more non-position attributes when processing the primitive that underwent the clipping process.

11. A graphics processor operable to execute a tile-based graphics processing pipeline to generate a render output, the graphics processor comprising one or more processing circuits configured to execute a graphics processing pipeline comprising:
a sequence of one or more geometry processing stages to perform geometry processing;
a binning stage that performs a binning process to generate data structures for identifying geometry to be processed for respective rendering tiles of a render output being generated;
a rendering stage for rendering tiles of a render output being generated;
wherein:
the graphics processor further comprises a clipping processing circuit configured to, when the graphics processor is generating a render output in which primitives to be rendered can be clipped against a clip plane defined for the render output, for a primitive to be processed for the render output being generated and that is to undergo a clipping process as part of its processing for the render output:
perform a clipping process for the primitive; and
when the clipping process generates one or more new vertices for the primitive, generate position attributes for the new vertices that are generated as a result of the clipping process;
and
the rendering stage processing circuit is configured to use the position attributes generated by the clipping process for new vertices generated as a result of the clipping process for a primitive when determining the values of one or more non-position attributes when processing a primitive that underwent the clipping process for a render output.

12. The graphics processor of claim 11 wherein the position attribute(s) that are generated by the clipping process for a new vertex comprise one or more of:
barycentric coordinates for the new vertex; and
a clip space position for the new vertex.

13. The graphics processor of claim 11, wherein the position attributes generated by the clipping process for the new vertices for a primitive are provided to the rendering process in a binning data structure that is provided to the rendering process.

14. The graphics processor of claim 11, wherein the clipping process for a primitive is performed by executing a graphics shader program that performs the clipping process for the primitive.

15. The graphics processor of claim 11, comprising a processing circuit configured to:
determine whether a primitive should undergo a clipping process as part of its processing for a render output; and
when it is determined that a primitive should undergo a clipping process as part of its processing for a render output, trigger the performing of a clipping process for the primitive.

16. The graphics processor of claim 11, wherein the values of one or more non-position attributes for the original vertices of the primitive that underwent the clipping process are provided to the rendering stage processing circuit.

17. The graphics processor of claim 11, wherein the non-position attribute(s) for which values are determined by the rendering stage processing circuit using the position attributes generated by the clipping process for new vertices generated as a result of the clipping process for a primitive comprises colour and/or transparency attribute(s).

18. The graphics processor of claim 11, wherein the rendering stage processing circuit is configured to use the position attributes generated by the clipping process for the new vertices generated as a result of the clipping process for the primitive when determining the values of one or more non-position attributes when processing the primitive that underwent the clipping process, when the value of a non-position attribute for a sampling position for a fragment being rendered for a clipped primitive falls to be determined during fragment processing.

19. The graphics processor of claim 11, wherein the rendering stage processing circuit comprises:
a rasterisation stage processing circuit configured to rasterise primitives to be rendered to respective fragments each representing a set of one or more sampling positions that are covered at least in part by the primitive being rendered, followed by a fragment processing stage processing circuit configured to generate non-position attribute values for fragments for primitives that are generated by the rasterisation stage processing circuit; and
the fragment processing stage processing circuit is configured to trigger the using of the position attributes generated by the clipping process for the new vertices generated as a result of the clipping process for a primitive that underwent the clipping process when determining the values of one or more non-position attributes when processing a primitive that underwent the clipping process.

20. A non-transitory computer readable storage medium storing software code which when executing on one or more processors performs a method of operating a graphics processor when executing a tile-based graphics processing pipeline to generate a render output, the graphics processing pipeline being executed comprising:
a sequence of one or more geometry processing stages to perform geometry processing;
a binning stage that performs a binning process to generate data structures for identifying geometry to be processed for respective rendering tiles of a render output being generated;
a rendering stage for rendering tiles of a render output being generated;
the method comprising, when generating a render output in which primitives to be rendered can be clipped against a clip plane defined for the render output, for a primitive to be processed for the render output being generated and that is to undergo a clipping process as part of its processing for the render output:
performing a clipping process for the primitive; and
when the clipping process generates one or more new vertices for the primitive, the clipping process generating position attributes for the new vertices that are generated as a result of the clipping process;
and, thereafter:
the rendering stage using the position attributes generated by the clipping process for the new vertices generated as a result of the clipping process for the primitive when determining the values of one or more non-position attributes when processing the primitive that underwent the clipping process for the render output.
